(19) United States
(12) Patent Application Publication
(10) Pub. No.: US 2023/0320536 A1
(43) Pub. Date: Oct. 12, 2023

(54) ENCLOSURE SYSTEM INCORPORATING A CARTRIDGE ASSEMBLY HOUSING AN EXTENDABLE AND RETRACTABLE ENCLOSURE PANEL

(71) Applicant: Systems & Patents 2000, Sociedad Limitada, Palleja (ES)

(72) Inventor: Marcelo Rosell Rosell, Palleja (ES)

(21) Appl. No.: 17/735,334

(22) Filed: May 3, 2022

(30) Foreign Application Priority Data
Apr. 7, 2022 (ES) U 202230589

(51) Int. Cl. A47K 3/34; E05D 15/10

(52) U.S. Cl. CPC A47K 3/34; E05D 15/10; E05Y 2900/114; E05D 2015/1026

(57) ABSTRACT

An enclosure system having a cartridge assembly with a flexible panel is provided for use in forming an enclosed area. The cartridge assembly may be replaceable and may include a shell, a rotatable drum located inside the shell, and a tensioning mechanism. The flexible panel may extendably and retractably wind on the drum. The tensioning mechanism may load when unwinding the flexible panel from the drum, and when loaded, may rotate the drum to wind the flexible panel onto the drum. The tensioning system may include a braking surface which rotates jointly with the drum. When the tensioning system drives the drum to wind the flexible panel, the braking surface may friction against the shell, dampening the winding of the flexible panel onto the drum. The tensioning mechanism may be adjusted to select the dampening strength.

### CROSS-REFERENCE TO RELATED APPLICATION

This application claims priority to Spanish Utility Model Application No. U 202230589, filed on Apr. 7, 2022, which is incorporated by reference herein in its entirety.

### FIELD OF THE INVENTION

The present invention relates generally to retractable enclosure panels and, more particularly, to an enclosure system incorporating a replaceable cartridge housing an extendable and retractable enclosure panel.

### BACKGROUND OF THE INVENTION

Shower screens are generally positioned on bath and shower spaces, generally defined by surrounding walls, in order to prevent water from splashing outside the bath or shower area delimited by the walls and the screen. Generally, these screens have a peripheral frame which is attached to the walls, and onto which closure elements (e.g., screens or panels) are mounted to enclose the bath or shower space during use.

In some cases, these closure elements consist of generally rigid, sliding panels. The panels may be made of glass, and may be mounted on guides defined in upper and lower uprights of the frame. A user may slide one or more of the panels to an open position in which the panels define an opening through which the user may enter or exit the shower area. Alternatively, the user may slide one or more of the panels to a closed position in which the panels enclose the shower area, such as for showering, or to simply conceal the shower area.

Existing shower panels or screens feature different problems. For example, shower panels may be difficult to clean. The panels may be so heavy that correct operation of the panels between the open and closed positions is cumbersome. Furthermore, glass panels may break and cause harm to surrounding persons or damage nearby objects.

Alternative enclosures are known in which the closure element is formed by a flexible sheet or panel, which may be made of plastic, and which winds onto and unwinds from a rotating drum. When the panel is rolled onto the drum, free access is provided to the inner area of the peripheral frame. Alternatively, the panel may be unrolled from the drum to provide enclose the bath or shower space.

In this type of screen, the flexible sheet rolls up over the rotating drum due to the action of preloaded torsion springs, which act on the rotating drum and bias the drum to rotate in the rolling direction of the sheet over the drum.

In these known roller screens, the rotating drum, as well as the means causing rotation thereof for the rolling-unrolling of the sheet, are mounted to or form part of a vertical profile or upright comprised in the peripheral frame. The profile typically includes a slot through which the flexible sheet is extended and retracted.

Documents WO2002/065884, WO2004/054419, ES2020454, ES1033753, ES1034999, and ES1036044 describe examples of closing mechanisms in which the elements causing rotation of the roll-up device, as well as the flexible sheet, are contained within or form part of one of the uprights or vertical profiles of the peripheral frame, which in turn is fixed to the building side walls, partitions or walls.

In order to maintain or repair these known roller systems, it is typically necessary to totally or partially dismount the upright (which houses the rolling means), which in turn generally requires removal of the peripheral frame. These actions are relatively complex and must be normally carried out by a qualified technician. In some cases, the qualified technician may not even be able to repair the unit, in which case the enclosure system must be entirely removed and replaced by a new enclosure model. In other cases, in which some parts of the enclosure system may be susceptible or repair of replacement, these operations can neither be carried out in a simple or quick manner, nor be performed, by the users themselves, and instead must be performed by qualified professional staff. The qualified staff must firstly determine the specific problem, and then proceed to repair the part. Often, the qualified staff determines the enclosure must be replaced with a different enclosure from the many which are commercially available, at a high cost and after a high period of time.

Accordingly, there is need for a solution to at least one of the aforementioned problems. For instance, there is an established need for a shower enclosure system having an extendable and retractable panel, wherein the panel and other parts of the system may be easily replaced when deteriorated without the need for a qualified professional.

### SUMMARY OF THE INVENTION

The present invention is directed to an enclosure system having a cartridge assembly with a reinforced, extendable and retractable flexible panel.

In a first implementation of the invention, an enclosure system for selectively enclosing a shower area or other space comprises a cartridge assembly. The cartridge assembly may include a shell, a drum, and a flexible panel. The drum may be housed inside the shell and may be rotatable relative to the shell about a rotation axis arranged in a longitudinal direction. The flexible panel may be configured retract into or extend from the shell and respectively wind on or unwind from the drum. When extended from the shell, the flexible panel may enclose a space. The cartridge assembly may further include at least one tensioning mechanism configured to spring-load the drum to rotate in a winding direction for winding the flexible panel on the drum. Each tensioning mechanism may include a braking surface rotatable jointly with the drum. The cartridge assembly may be configured to adopt a winding configuration, in which the drum rotates in the winding direction and the braking surface of each tensioning mechanism of the at least one tensioning mechanism frictions against the shell.

In a second aspect, the braking surface may be configured to friction against an inner side of the shell oriented towards the drum.

In another aspect, the tensioning mechanism may be located at a longitudinal end of the drum.

In another aspect, the at least one tensioning mechanism may include two tensioning mechanisms. Each tensioning mechanism of the two tensioning mechanisms may be arranged at a respective longitudinal end of the drum.

In another aspect, the cartridge assembly may further include an end cap arranged at the longitudinal end of the drum. The end cap may be jointly rotatable with the drum. The braking surface of the tensioning mechanism may be provided on the end cap.

In yet another aspect, the braking surface may be provided by a radially protruding flange located at the longitudinal end of the drum.

In another aspect, the tensioning mechanism may further include a torsion spring. A first longitudinal end of the torsion spring may be located closer to the longitudinal end of the drum than an opposite, second longitudinal end of the torsion spring. The second longitudinal end of the torsion spring may be non-rotatably engaged with the drum. The cartridge assembly may be configured to adopt an unwinding configuration in which the drum rotates in an unwinding direction opposite to the winding direction. In both the winding and unwinding configurations, the first longitudinal end of the torsion spring may be non-rotatably engaged with the shell, and the drum may be rotatable relative to the first longitudinal end of the torsion spring and the shell. In the unwinding configuration, the drum may drive the second longitudinal end of the torsion spring to rotate in the unwinding direction relative to the first longitudinal end of the torsion spring thereby loading the torsion spring. In the winding configuration, the torsion spring may be loaded and the second longitudinal end of the torsion spring may drive the drum to rotate in the winding direction.

In another aspect, the second longitudinal end of the torsion spring may be longitudinally translatable relative to the drum.

In another aspect, the tensioning mechanism may further include an inner tube arranged inside the drum. A first longitudinal end of the inner tube may be located closer to the longitudinal end of the drum than an opposite, second longitudinal end of the inner tube. In the winding configuration of the cartridge assembly, the second longitudinal end of the torsion spring may exert a longitudinal force on the second longitudinal end of the inner tube towards the longitudinal end of the drum, and the first longitudinal end of the inner tube may responsively exert a force on the braking surface which increases a friction between the braking surface and the shell.

In yet another aspect, the inner tube may be translatable relative to the drum along the longitudinal direction.

In another aspect, the torsion spring may be arranged inside the inner tube.

In another aspect, the tensioning mechanism may further include a spring connector attached to the second longitudinal end of the torsion spring. In the winding configuration of the cartridge assembly, the spring connector may abut against and may exert the longitudinal force on the second longitudinal end of the inner tube.

In another aspect, the spring connector may be non-rotatably engaged with the second longitudinal end of the torsion spring and with the drum. The spring connector may be configured to transfer rotation of the drum to the second longitudinal end of the torsion spring in the unwinding configuration of the cartridge assembly. Conversely, the spring connector may be configured to transfer rotation of the second longitudinal end of the torsion spring to the drum in the winding configuration of the cartridge assembly.

In yet another aspect, the spring connector may be longitudinally slidable relative to the drum. In the unwinding configuration of the cartridge assembly, the torsion spring may be extended relative to the winding configuration and thereby may exert less or no longitudinal force on the second longitudinal end of the inner tube towards the longitudinal end of the drum relative to the winding configuration, reducing or eliminating the friction on the shell relative to the winding configuration.

In another aspect, the cartridge assembly may be further configured to adopt an adjustment configuration, in which the first longitudinal end of the torsion spring may be disengaged from the shell and rotatable relative to the shell to modify a rotational position of the first longitudinal end of the torsion spring relative to the second longitudinal end of the torsion spring to adjust a tension of the torsion spring.

In another aspect, the cartridge assembly may further include an adjustment shaft non-rotatably attached to the first longitudinal end of the torsion spring. The adjustment shaft may extend through and may be operable from outside the shell. The adjustment shaft may be configured to selectively switch between an unlocked configuration and a plurality of locked configurations. In the unlocked configuration, the adjustment shaft may be extended outward of the shell and rotatable relative to the shell. In each locked configuration of the plurality of locked configurations, the adjustment shaft may be displaced towards the shell and locked in a different, respective rotational position relative to the shell and prevented from rotating relative to the shell. In the winding and unwinding configurations of the cartridge assembly, the adjustment shaft may be arranged in a selected locked configuration of the plurality of locked configurations. In the adjustment configuration of the cartridge assembly, the adjustment shaft may be arranged in the unlocked configuration.

In another aspect, in the unlocked configuration, the adjustment shaft may be disengaged from a plurality of stops formed in the shell. In each locked configuration, the adjustment shaft may be prevented from rotating relative to the shell by at least one of the plurality of stops.

In yet another aspect, the cartridge assembly may further include at least one drain opening formed through a bottom end of the shell and configured to drain water from inside the shell.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a top, front isometric view of an enclosure system in accordance with an illustrative embodiment of the present invention, the enclosure system comprising a frame, a replaceable cartridge attached to the frame, and a flexible panel extendable from the cartridge, the enclosure system shown in first or open position in which the flexible panel is fully retracted into the cartridge;

FIG. 2 presents a top, front isometric view of the enclosure system of FIG. 1 shown in a second position, in which the flexible panel partially extended along the frame of the enclosure system;

FIG. 3 presents a top, front isometric view of the enclosure system of FIG. 1 shown in a third position, in which the flexible panel further partially extended along the frame of the enclosure system and a support post of the enclosure system deployed at a corner of the frame;

FIG. 4 presents a top, front isometric view of the enclosure system of FIG. 1 shown in a fourth or closed position, in which the shower panel is fully extended and secured to the frame of the shower enclosure and encloses a shower area;

FIG. 5 presents a top, front isometric view of a first or lead post of the enclosure system of FIG. 1, the lead post including a double latch assembly and a pair of rollers of a roller system of the enclosure system;

FIG. 6 presents an enlarged, exploded top, front right-side isometric view of the double latch assembly of FIG. 5;

FIG. 7 presents an enlarged, top, front left-side isometric view of the first post and double latch assembly of FIG. 5 prior to engagement with a clip of the double latch assembly mounted in the frame;

FIG. 8 presents an enlarged, top, front right-side isometric view of the first post and double latch assembly of FIG. 5 prior to engagement with the clip of the double latch assembly mounted in the frame;

FIG. 9 presents a front elevation view of the first post and double latch assembly of FIG. 5, during engagement of a pair of latches of the double latch assembly with the clip of the double latch assembly to secure the first post to the frame;

FIG. 10 presents a front elevation view of the first post and double latch assembly of FIG. 5, during disengagement of the pair of latches of the double latch assembly from the clip of the double latch assembly to release the first post from the frame;

FIG. 11 presents a top, front isometric view of a second or support post of the enclosure system illustrated in FIG. 1, including additional pairs of rollers of a roller system of the enclosure system and stop members for limiting the travel of the second post along the frame;

FIG. 12 presents an exploded top, rear isometric view of a lower track assembly of the frame of the enclosure system of FIG. 1, the lower track assembly including a corner stop;

FIG. 13 presents an exploded top, front isometric view of the lower track assembly of FIG. 12;

FIG. 14 presents a cross-sectional top plan view of the lower track assembly of the frame and the first and second posts of the enclosure system of FIG. 1, illustrating the combined lead and support posts advancing towards the corner stop of the lower track assembly;

FIG. 15 presents a cross-sectional top plan view, similar to FIG. 14, illustrating the lead post passing the corner stop of the lower track assembly and the movement of the support post being arrested by the corner stop of the lower track assembly;

FIG. 16 presents a transverse, cross-sectional view of a portion of the lower track assembly of the frame of the enclosure system;

FIG. 17 presents a transverse cross-sectional view of the lower track assembly with inner and outer rollers the roller system of the second post positioned in the lower track assembly;

FIG. 18 presents an exploded, top front isometric view of the replaceable cartridge assembly of the enclosure system of FIG. 1;

FIG. 19 presents an enlarged, top front isometric view of a panel tensioning mechanism of the replaceable cartridge assembly of FIG. 18;

FIG. 20 presents an enlarged, top front isometric view of a top area of the spring tensioning mechanism of FIG. 19, with a spring tensioning mechanism shown in a lowered or locked condition;

FIG. 21 presents an enlarged, top front isometric view similar to FIG. 20, with the spring tensioning mechanism shown in a raised or unlocked condition to adjust panel pre-tension;

FIG. 22 presents a cross-sectional side elevation view of top and bottom areas of the replaceable cartridge assembly of FIG. 18, with the spring tensioning mechanism in the unlocked condition;

FIG. 23 presents a cross-sectional side elevation view of a lower portion of the string tensioning mechanism, illustrating a bottom spring connector of the spring tensioning mechanism positioned within a drum of the replaceable cartridge assembly;

FIG. 24 present a top plan view of the replaceable cartridge assembly of FIG. 18, with the tensioning mechanism in the locked condition;

FIG. 25 presents a top plan view, similar to FIG. 24, of the replaceable cartridge assembly of FIG. 18, with the tensioning mechanism in the unlocked condition during pre-tensioning of the drum of the replaceable cartridge assembly;

FIG. 26 presents a cross-sectional top, front isometric view of the assembled replaceable cartridge assembly of FIG. 18, the cartridge assembly shown in an initial condition corresponding to the open position of the enclosure system shown in FIG. 1;

FIG. 27 presents a cross-sectional side elevation view of the assembled replaceable cartridge assembly of FIG. 18 in the initial condition of FIG. 26;

FIG. 28 presents a cross-sectional side elevation view, similar to FIG. 27, of the assembled replaceable cartridge assembly of FIG. 18, where the replaceable cartridge is arranged in a final condition corresponding to the closed position of the enclosure system shown in FIG. 4;

FIG. 29 presents a cross-sectional side elevation view of the assembled replaceable cartridge assembly in accordance with another embodiment of the invention, the cartridge assembly including top and bottom tensioning mechanisms, each including a respective dampening mechanism;

FIG. 30 presents a top plan view of an inner end of the shower panel of the enclosure system engaged with the drum of the enclosure system of FIG. 18;

FIG. 31 presents a top, front isometric view of a foldable ramp system for use with the lower track of the disclosed enclosure system, the foldable ramp system shown in a fully deployed condition over the lower track;

FIG. 32 presents a top, front isometric view, similar to FIG. 31, of the foldable ramp system in an unfolded condition;

FIG. 33 presents a cross-sectional side elevation view, taken along section plane 33-33 indicated in FIG. 31; and

FIG. 34 presents a cross-sectional side elevation view, taken along section plane 34-34 indicated in FIG. 32.

Like reference numerals refer to like parts throughout the several views of the drawings.

### DETAILED DESCRIPTION

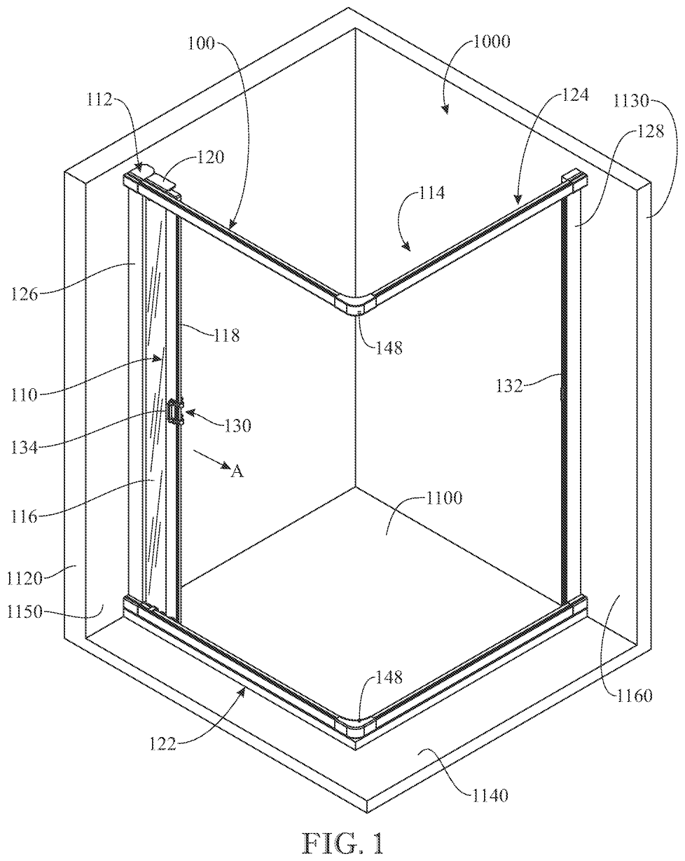

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The present invention is directed toward an enclosure system incorporating a replaceable cartridge assembly, which includes a cartridge that houses an extendable and retractable enclosure panel. The enclosure system may be used, for instance and without limitation, to enclose a shower or bath area inside a home or at another facility, such that the shower or bath area may be used with privacy.

The illustrations of FIGS. 1-4 present an enclosure system 100 in accordance with an exemplary embodiment of the present invention for use, for instance and without limitation, in a stall or shower area 1000. With reference initially to FIG. 1, the enclosure system 100 includes a replaceable cartridge and panel assembly 110, which comprises a cartridge assembly 112 mounted to a frame 114 of the enclosure system 100. The replaceable cartridge and panel assembly 110 additionally includes a flexible enclosure sheet or panel 116 which is initially housed within the cartridge assembly 112 and which is extendable and retractable therefrom along the frame 114 to form an enclosure within the shower area 1000 to contain shower water (not shown) and prevent the water from spraying out the enclosed area, and to provide privacy to a person showering within the shower area 1000.

The replaceable cartridge and panel assembly 110 further includes a first or lead post 118 and a second or support post 120. The lead post 118 is affixed to the flexible panel 116 and is operable by a user to extend and retract the flexible panel 116 in and out of the cartridge assembly 112. The support post 120 supports the flexible panel 116 during movement or positioning of the flexible panel 116 along the frame 114 as discussed in more detail hereinbelow. The flexible panel 116, along with the lead post 118 and the support post 120, are movable along a bottom track assembly 122 of the frame 114 and an opposing, spaced apart top track assembly 124 of the frame 114.

In order to support the bottom and top track assemblies 122 and 124, respectively, in a spaced-apart position relative to one another, the frame 114 of the enclosure system 100 may include a first vertical support 126 and a second vertical support 128. The bottom track assembly 122 and the top track assembly 124 may be affixed to or mounted on the first and second vertical supports 126 and 128, respectively, to form a generally rigid frame 114.

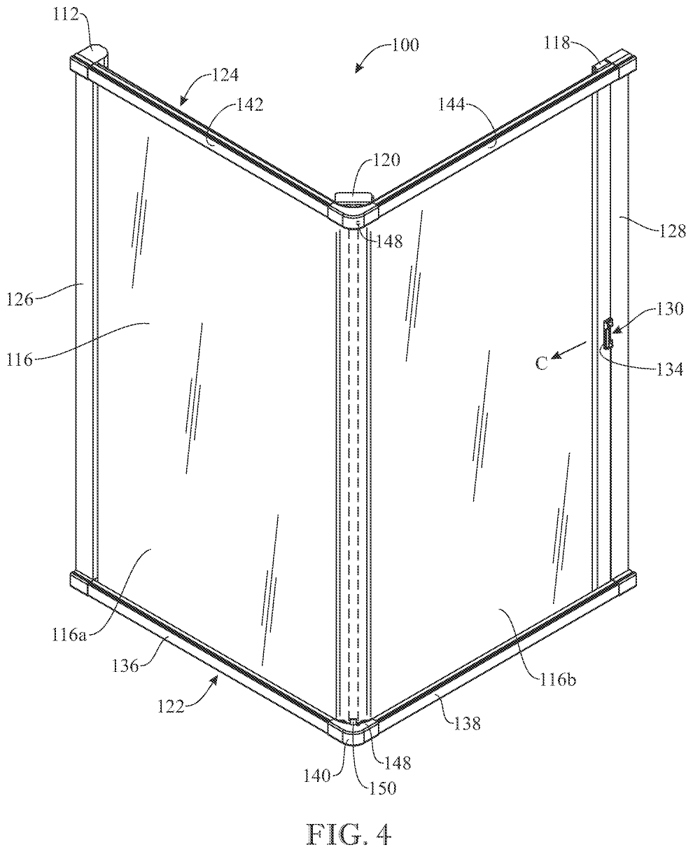

The lead post 118 of the replaceable cartridge and panel assembly 110 is movable along and guided by the bottom and top track assemblies 122 and 124 to draw the flexible panel 116 along the bottom and top track assemblies 122 and 124, as shown in FIGS. 1-4. Sufficient pulling of the lead post 118 and, consequently, of the flexible panel 116 affixed thereto, eventually causes the flexible panel 116 to reach a closed position in which the flexible panel 116 encloses the shower area 1000, as shown in FIG. 4. In order to prevent the flexible panel 116 in the closed position of FIG. 4 from inadvertently opening, the lead post 118 includes a latch assembly 130 which is releasably engageable with an inner surface of the second vertical support 128 to releasably secure the lead post 118 to the second vertical support 128 and thus secure the flexible panel 116 in an extended condition with respect to the frame 114, or closed position of the flexible panel 116. As further shown in FIGS. 1-4, a handle 134 is provided on the lead post 118 to facilitate manually moving the lead post 118, and thus the flexible panel 116, along the bottom and top track assemblies 122 and 124, respectively.

As noted above, the enclosure system 100 may be provided for use in enclosing a stall or shower area 1000 of the kind typically found in homes, office buildings and stores and the like. Additionally, the enclosure system 100 may find use in outdoor shower areas such as those in public pool or beach areas or in private outdoor locations adjacent a homeowner's pool or house. In other applications, the enclosure system 100 may be used to enclose any type of area, whether it be for showering, bathing or other uses. For simplicity, the present detailed description will refer mainly to shower, bath or otherwise humid areas; however, unless otherwise expressed, the terms “shower” or “bath” are to be understood as non-limiting and encompassing any area capable of being enclosed by the invention.

With reference to FIG. 1, the shower area 1000 may include a floor 1100 and one or more walls, such as, but not limited to, a first wall 1120 and a second wall 1130. The frame 114 of the disclosed enclosure system 100 is mounted to the shower area 1000 and the replaceable cartridge and panel assembly 110 is removably mounted onto the frame 114, such that the replaceable cartridge and panel assembly 110 may be removed from the frame 114 for replacement in the event of damage or excessive wear to the flexible panel 116 and/or other components of the replaceable cartridge and panel assembly 110.

The frame 114 of the disclosed enclosure system 100 may be fixedly attached to the shower area 1000 by securing the bottom track assembly 122 of the frame 114 to an upper surface 1140 of the floor 1100, to an upper rim of a bathtub (not shown), or to another applicable frame-supporting structure. Additionally, the first vertical support 126 of the frame 114 may be secured to an outer surface 1150 of the first wall 1120 and the second vertical support 128 of the frame 114 is secured to an outer surface 1160 of the second wall 1130. The top track assembly 124 may be supported between the first and second vertical supports 126 and 128, respectively, as shown. Alternatively or additionally, the top track assembly 124 may be secured to a ceiling of the shower area 1000.

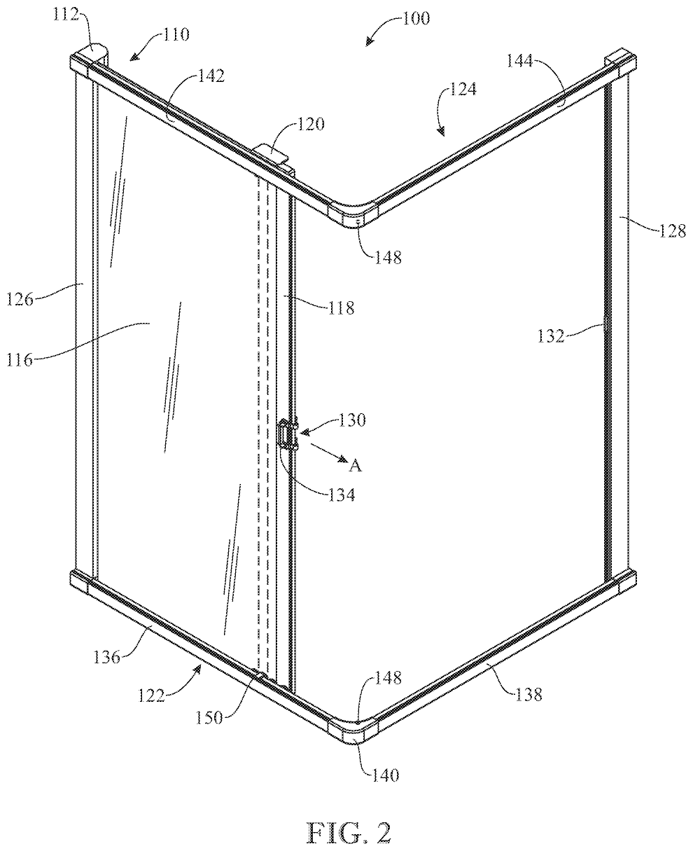

Turning now to FIG. 2, the disclosed bottom and top track assemblies 122 and 124, respectively, may be straight, curved, angled, or combinations thereof, depending on the type of installation and the shape of the shower area 1000 (FIG. 1). In some embodiments, the bottom track assembly 122 and/or the top track assembly 124 may be length-adjustable, to facilitate installing the enclosure system 100 in different shower areas 1000 or other areas. In other embodiments, the bottom track assembly 122 and/or the top track assembly 124 may have a predetermined length.

For example, in the illustrated embodiment, the bottom and top track assemblies 122 and 124 are angled, and both the bottom track assembly 122 and the top track assembly 124 are length-adjustable. The bottom track assembly 122 of the present embodiment includes a first linear track segment or assembly 136, a second linear track segment or assembly 138, and a corner piece or assembly 140 intermediate the first and second extendable linear track assemblies 136 and 138, respectively. Similarly, the top track assembly 124 includes a first linear track segment or assembly 142, a second linear track segment or assembly 144, and a corner piece or assembly 146 intermediate the first and second extendable linear track assemblies 142 and 144, respectively. The first and second linear track assemblies 136 and 138 of the bottom track assembly 122 and the first and second linear track assemblies 142 and 144 of the top track assembly 124 of the present embodiment are length-adjustable such that they may be extended and compressed to allow the frame 114 to be adjusted to fit a specific size shower area 1000 as discussed in more detail hereinbelow.

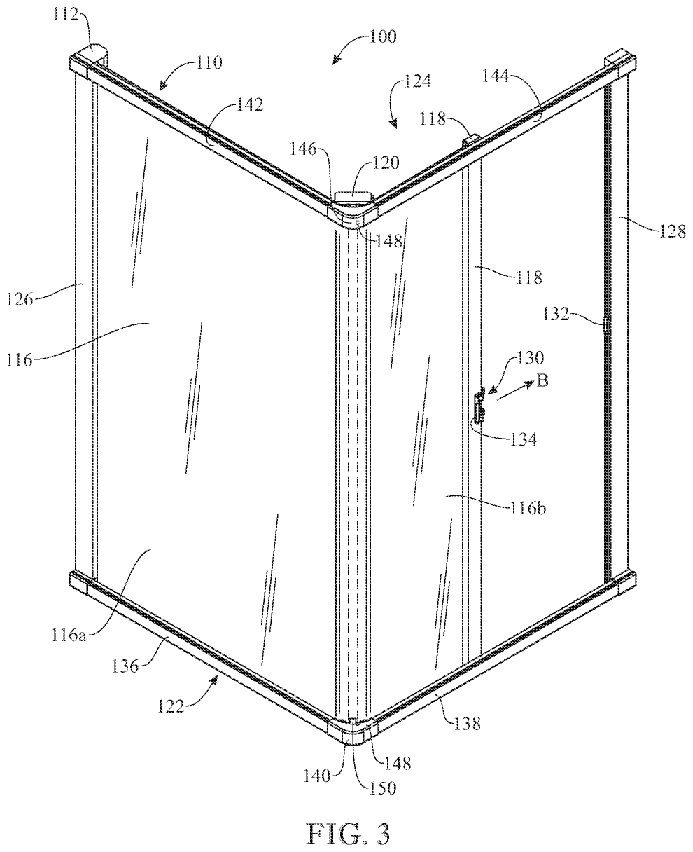

As noted hereinabove, the replaceable cartridge and panel assembly 110 includes two moving posts, namely, the lead post 118 and the support post 120. Initially, the support post 120 is attached to the lead post 118 and is pulled forward together with the lead post 118 and flexible panel 120 (FIGS. 1 and 2). As the support post 120 reaches the area of the corner (i.e. the area of the corner assemblies 140 and 146), the support post 120 is stopped such that the support post 120 remains in said area as the lead post 118 while the flexible panel 116 continues to be pulled towards the closed position (as shown in FIGS. 3 and 4). In order to stop the movement of the support post 120 along the bottom and top track assemblies 122 and 124 at the respective corner assemblies 140 and 146, one or both of the bottom corner assembly 140 and the top corner assembly 146 includes a projecting stopper or stop pin 148 configured to engage with, and block forward movement, of a corresponding projecting stop bar 150 comprised in the support post 120, all of which are described in greater detail hereinafter. Once the support post 120 is stopped at the corner assemblies 140 and 146 of the bottom and top track assemblies 122 and 124, the support post 120 provides back-up support to the flexible panel 116 at the corner assemblies 140 and 146 to prevent the flexible panel 116 from sagging or bowing in as the flexible panel 116 is drawn around the corners formed in the bottom and top track assemblies 122 and 124, respectively, as shown in FIG. 3, and once the flexible panel 116 is arranged in the closed position of FIG. 4.

Referring now to FIGS. 1-4, and initially with regard to FIG. 1, in basic use, the cartridge assembly 112 is releasably mounted to the first vertical support 126 and the flexible panel 116 is initially substantially retained within the cartridge assembly 112. The lead post and support posts 118 and 120, respectively, are positioned adjacent the cartridge assembly 112 with the support post 120 releasably connected to the lead post 118 as discussed hereinbelow. The flexible panel 116 is affixed to the lead post 118 in known manner.

The shower area 1000 is accessible by entering the shower area 1000 through the open frame 114. Once a person has positioned themselves within the shower area 1000, the flexible panel 116 is drawn out of the cartridge assembly 112 (for example by said person pulling on the handle 134) to enclose the shower area. By pulling on the handle 134, the lead post 118 is pulled along the first linear track assembly 136 of the bottom track assembly 122 and the first linear track assembly 142 of the top track assembly 124 to move the flexible panel 116 in the direction of arrow “A” shown in FIGS. 1 and 2. This advancement of the flexible panel 116 is facilitated by the use of the handle 134 on the lead post 118.

With reference to FIGS. 2 and 3, continued pulling of the handle 134 causes the lead post 118 and flexible panel 116 to be jointly pulled around the corner assemblies 140 and 146 in the direction of arrow “B” towards the second vertical support 128. As the support post 120 arrives at the corner assemblies 140 and 146 of the bottom and top track assemblies 122 and 124, respectively, the stop bar 150 on the support post 120 engages the stop pin 148 on the lower corner assembly 140 and is prevented from moving further along the bottom and top track assemblies 122 and 124. It should be noted that, as will be described in greater detail below, a similar stop pin 148 may be alternatively or additionally provided on the upper corner assembly 146 and a similar stop bar may be provided at the top end of the support post 120. When the support post 120 is stopped by the stop pin 148, continued pulling on the handle 134 of the lead post 118 pulls the lead post 118 free from its releasable engagement with the support post 120 leaving the support post 120 in position at the corner assemblies 140 and 146, as shown in FIG. 3. The support post 120, now positioned at the bend or corner in the frame 114, provides a vertical support for the flexible panel 116 to turn the corner and not sag or flex inward as it passes through the corner in the frame 114.

As shown in FIG. 4, continued pulling on the handle 134 causes the lead post 118 to continue moving along the second linear track assembly 138 of the bottom track assembly 122 and the second linear track assembly 144 of the top track assembly 124 until the lead post 118 engages the second vertical support 128. The latch assembly 130, positioned on the lead post 118, may be engaged with the inner edge 132 of the second vertical support 128 to lock the lead post 118 to the second vertical post 128 in a manner described in more detail hereinbelow.

Once the user has completed their shower, the latch assembly 130 may be disengaged from the second vertical support 128 and the handle 134 grasped to reverse the process by pulling on the handle 134 and moving the lead post 118 back in the direction of arrow “C”. The lead post 118 may be moved back along the bottom and top track assemblies 122 and 124 until it reengages the support post 120 such that the lead post 118 and support post 120 become reconnected and jointly movable with the flexible panel 116 along the bottom and top track assemblies 122 and 124. Further movement of the lead post 118 moves the lead post 118 and the support post 120 back towards the cartridge assembly 112. The flexible panel 116 is biased inwardly with respect to the cartridge assembly 112 to draw the flexible panel 116 into the cartridge assembly 112 and prevent the flexible panel 116 from bunching up as the lead and support posts 118 and 120, respectively, are moved back to their original positions adjacent the cartridge assembly 112.

The components of the enclosure system 100, including the cartridge assembly 112, the frame 114, the flexible panel 116, the lead post 118 and the support post 120, may be formed from a variety of materials. For example, the flexible panel 116 may be formed from a variety of synthetic polymers and plastics and may be opaque or transparent. In some embodiments, such as for shower and bath applications, the flexible panel 116 is waterproof and provides a water barrier. The frame 114, along with the lead post 118 and the support post 120, may be formed from polymers and/or plastics or may be formed from metallic materials, such as, for example aluminum, stainless steel, etc. The cartridge assembly 112, as discussed in more detail hereinbelow, includes a large number of subcomponents with may also be formed from polymeric and/or metallic materials. Further, the frame 114 may be assembled by various known methods such as, but not limited to, bolting, screwing, welding, gluing, etc. the bottom and top track assemblies 122 and 124 to the first and second vertical supports 126 and 128 in known manner.

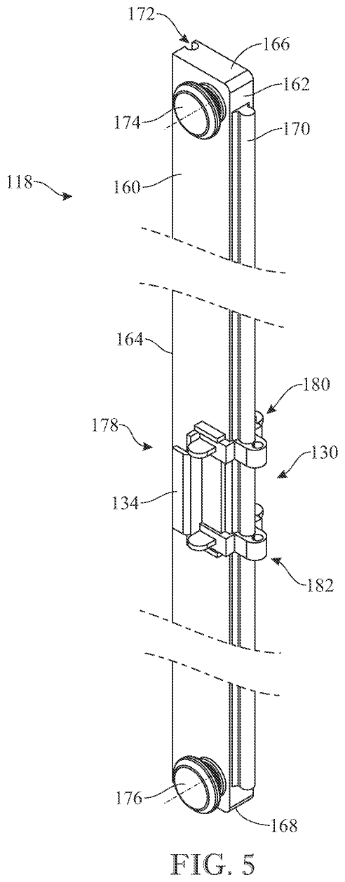

Turning now to FIGS. 5-29, and initially with regard to FIGS. 5-10, different components of the enclosure system 100 in accordance with certain embodiments of the invention will now be described in more detail. As best shown in FIG. 5, the lead post 118 may include an elongate, optionally flat, main body 160 extending generally from and between the bottom and top track assemblies 122 and 124. The main body 160 may have a leading edge 162, a trailing edge 164, a top end 166 and a bottom end 168. In order to releasably connect the lead post 118 to the second vertical support 128 when the flexible panel 116 is in the closed position (FIG. 4), the leading edge 162 of the main body 160 may be formed with or include at least one connection tube 170 extending along all or part of the length of the leading edge 162, and preferably along substantially the entire length of the leading edge 162 spanning between the top and bottom track assemblies 124 and 122. In some embodiments, the connection tube(s) 170 may have a cylindrical shape, which may be laterally truncated on the side of the cylinder on which the cylindrical connection tube 170 is secured to or extends from the leading edge 162 of the main body 160. Similarly, in order to releasably connect the lead post 118 to the support post 120 (as shown for instance in FIG. 2), the trailing edge 164 of the main body 160 may be provided with a generally cylindrical, flexible clip 172 extending along all or part of the length of the trailing edge 164 of the main body 160. The flexible clip 172 on the main body 160 is configured to releasably connect to a corresponding structure on the support post 120 as described in more detail hereinbelow.

With continued reference to FIG. 5, in order to smoothly move the lead post 118 along the bottom and top track assemblies 122 and 124, respectively, the lead post 118 may include at least one upper roller 174 rotatably mounted to the main body 160 adjacent the top end 166 of the main body 160 and at least one lower roller 176 rotatably mounted to the main body 160 adjacent the bottom end 168 of the main body 160. The upper roller 174 rides in the upper track assembly 124 of the frame 114 and the lower roller 176 rides in the lower track assembly 122 of the frame 114 in a manner described in more detail hereinbelow.

The latch assembly 130 and the handle 134 of the lead post 118 are positioned at a middle portion 178 of the elongated main body 160 of the lead post 118. The latch assembly 130 of the present embodiment generally includes a first or upper latch member 180 which rides along and is slidably mounted over the leading edge 162 of the main body 160 of the lead post 118 and a second or lower latch member 182 which also rides along and is slidably mounted over the leading edge 162 of the main body 160. The upper and lower latch members 180 and 182, respectively, are movable towards and away from each other to lock and unlock the lead post 118 from the second vertical support 128 as described below. The double-latch nature of the latch assembly 130 may reduce the risk of the latch assembly 130 becoming disconnected from the second vertical support 128 in the event that a person inadvertently hits or disengages one of the upper or lower latch members 180 or 182, respectively, which could result in the biased flexible panel 116 unexpectedly retracting back towards the cartridge assembly 112. Thus, the double-latch, latch assembly 130 may provide increased safety to the showering person, as it may enhance the ability of the closed, flexible panel 116 remaining in the closed position and supporting the person, in the event that the person loses stability while showering and accidentally leans on or falls on the flexible panel 116.

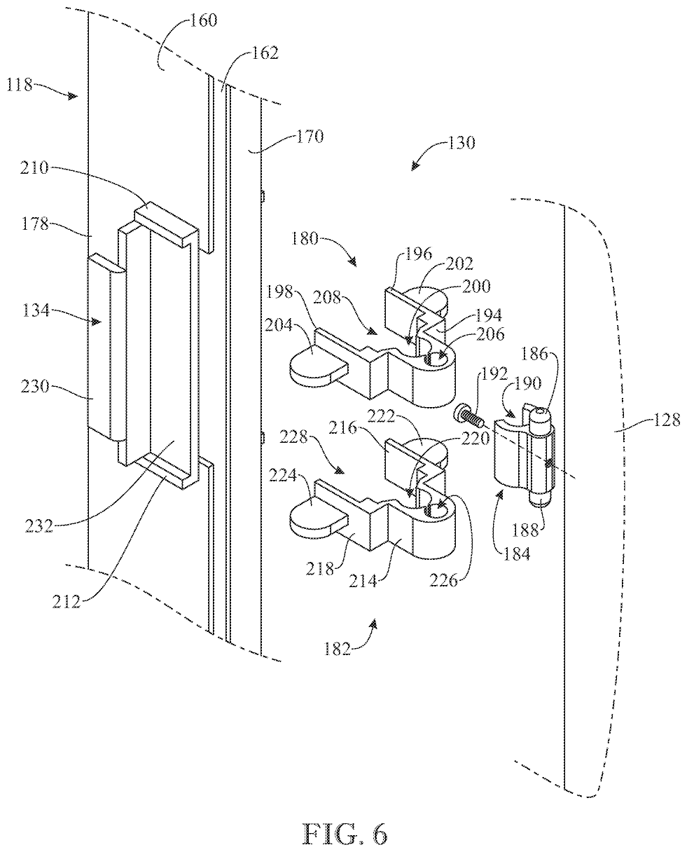

Turning now to FIG. 6, the upper and lower latch members 180 and 182 of the latch assembly are releasably engageable with a frame clip 184 mounted on the second vertical support 128. The frame clip 184 includes an upper pin 186 engageable with the upper latch member 180 and a lower pin 188 engageable with the lower latch member 182. The frame clip 184 further includes or defines a flexible clip 190. The flexible clip 190 is provided to elastically and releasably engage the connection tube 170 provided on the leading edge 162 of the main body 160 to releasably connect the lead post 118 to the second vertical support 128. The frame clip 184 is secured to the second vertical support 128 by a screw 192 or other similar fastener.

As noted above, the upper and lower latch members 180 and 182 are provided to lock onto the frame clip 184 to prevent the flexible panel 116 retracting accidentally or undesirably. The upper latch member 180 may generally include a body portion 194 having rearwardly extending, spaced-apart latch arms 196 and 198. The body portion 194 of the upper and lower latch members 180 and 182 may be slidably clipped onto or otherwise slidably engaged with the elongate bar 160 to movably mount the upper latch member 180 to the main body 160 and allow the upper latch member 180 to slide up and down relative to the frame clip 184 mounted on the second support member 128. The body portion 194 may define a first cavity 200 which may be formed as a through cavity configured to slidably receive the connection tube 170 of the main body 160. In some embodiments, the body portion 194 may be elastically clipped to the main body 160 by an elastic clip provided between the connection tube 170 and the first cavity 200. The latch arms 196 and 198 may be provided with respective finger tabs 202 and 204 to allow a user to easily slide the upper latch member 180 along the leading edge 162 of the main body 160 of the lead post 118. The finger tabs 202 and 204 may extend generally oppositely to one another from the elongate bar 160. In some embodiments, the finger tabs 202 and 204 may be horizontal. Alternatively or additionally, the finger tabs 202 and 204 may be generally flat (as shown) or alternatively include an ergonomic outer contour configured to adjust to one or more fingers.

The upper latch member 180 may further include or define a second cavity 206, which may extend into the body portion 194 from an underside of the body portion 194 and may be formed as a through cavity (as shown) or a blind cavity. The second cavity 206 is provided to receive the upper pin 186 of the frame clip 184, to engage the slidable upper latch member 180 to the frame clip 184 and thus securely lock the lead post 118 to the second vertical support 128. Furthermore, the latch arms 196 and 198 define a third cavity or gap 208 therebetween to fit around the main body 160 and the handle 134 as discussed below. The handle 134 is provided with an upper stop 210 to limit the upper travel of the upper latch member 180 relative to the handle 134. A lower stop 212 is also provided on the handle 134 to similarly limit the lower travel of the lower latch member 182 relative to the handle 134.

Similarly, the lower latch member 182 may include a body portion 214 having rearwardly extending, spaced-apart latch arms 216 and 218 and defining a first cavity 220 for slidably engaging the connection tube 170 on the main body 160 of the lead tube 118. The latch arms 216 and 218 also include respective finger tabs 222 and 224 to facilitate moving the second latch member 182 along the main body 160. The lower latch member 182 includes or defines a second cavity 226 for receipt of the lower pin 188 of the frame clip 184. The latch arms 216 and 218 define a third cavity 228 therebetween to fit around the main body 160 and the handle 134. The detailed description provided heretofore of each element comprised in the upper latch member 180 is applicable to the corresponding same element comprised in the lower latch member 182.

With continued reference to FIG. 6, the handle 134 may include a raised handle grip 230 configured to facilitate grasping the handle 134 and moving the lead post 118 along the bottom and top track assemblies 122 and 124. For instance, the raised handle grip 230 may extend outwardly from an L-shaped body portion 232 of the handle 134. While not specifically shown, a mirror-image raised handle grip may be alternatively or additionally provided on the body portion 232 of the handle 134 on the side of the body portion 232 opposite the raised handle grip 230.

The latch assembly 130 may be assembled to the lead post 118 by positioning the latch arms 196 and 198 of the upper latch member 180 about the leading edge 162 of the main body 160 and over the L-shaped body portion 232 of the handle 134. The latch arms 196 and 198 are positioned between the upper and lower stops 210 and 212 of the handle 134. The upper latch member 180 may then be pressed onto the connection tube 170 of the lead post 118 until the elastic clip at the first cavity 200 of the upper latch member 180 snaps over the connection tube 170. The lower latch member 182 may be similarly mounted to the lead post 118 by positioning the lower latch member 182 between the upper and lower stops 210 and 212 of the handle 134 and snapping the elastic clip at the first cavity 220 of the lower latch member 182 over the connection tube 170 of the lead post 118. The upper and lower latch members 180 and 182, respectively, of the latch assembly 130 are thereby retained on and slidably mounted to the lead post 118. It should be noted that the upper and lower latch members 180 and 182 frictionally engage the body portion 232 of the handle 134 to permit the upper and lower latch members 180 and 182 to remain in a raised or disconnected condition along the handle 134, and that said friction may be manually overcome with relative ease in order to manually slide the upper and lower latch members 180 towards and away from one another during operation of the handle 134.

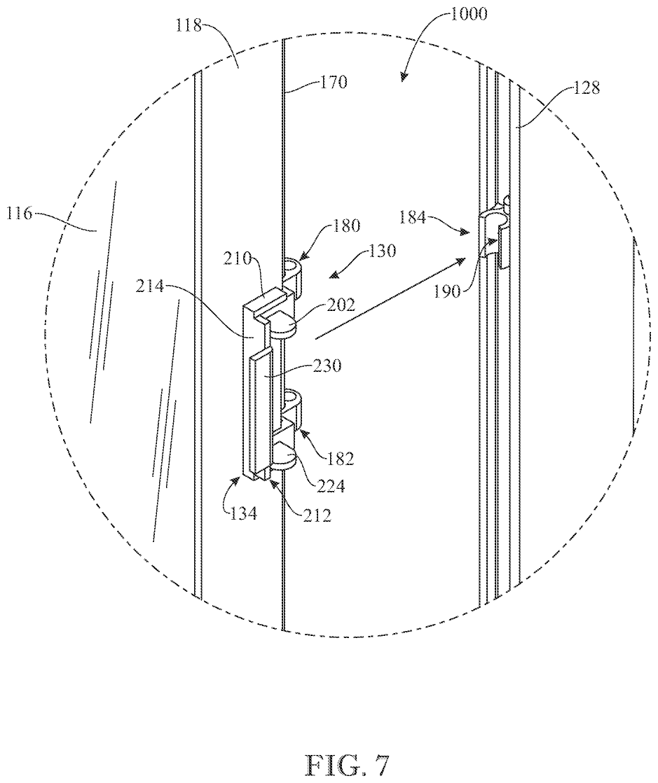

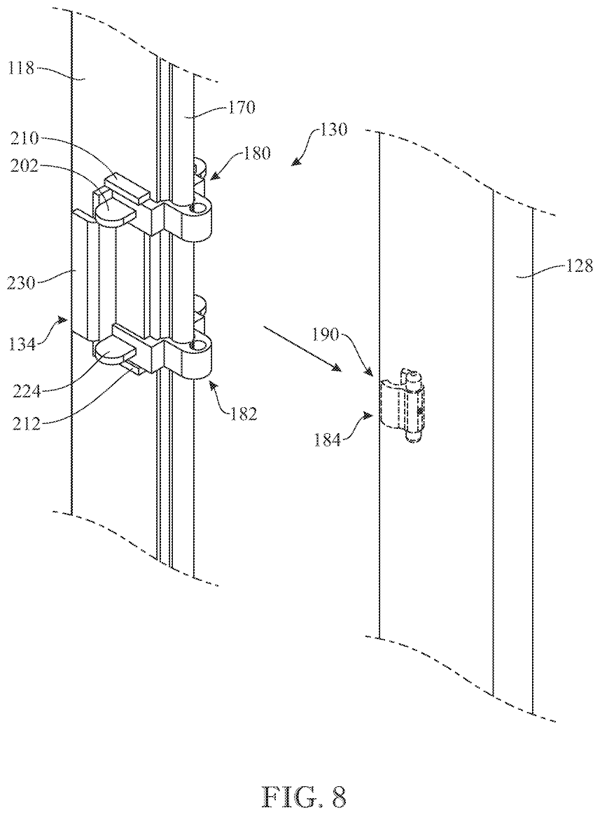

Turning now to FIGS. 7-10, and initially with regard to FIGS. 7 and 8, use of the connection tube 170 of the lead post 118 to releasably connect the lead post 118 to the second vertical support 128 and the use of the latch assembly 130 to subsequently lock the lead post 118 to the second vertical support 128 will now be described. Initially, the upper and lower latch members 180 and 182 of the latch assembly 130 are moved to a spaced apart condition adjacent the respective upper and lower stops 210 and 212 on the body portion 214 of the handle 134. The user initially advances the lead post 118 along the bottom and top track assemblies 222 and 224, respectively, to draw the flexible panel 116 out of the cartridge assembly 112 (FIG. 1) towards the second vertical support 128 to enclose the shower area 1000. Drawing of the flexible panel 116 is facilitated by grasping the raised handle grip 230 of the handle 134 and drawing the lead post 118 towards the second vertical support 128. The lead post 118 is moved towards the second vertical support 128 to move the connection tube 170 of the lead post 118 into a position to releasably engage the flexible clip 190 in the frame clip 184 mounted on the second vertical support 128.

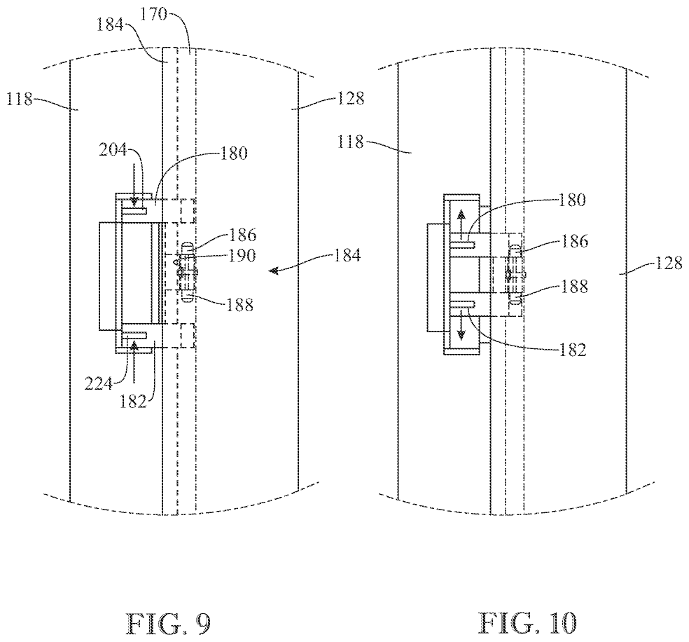

Turning now to FIGS. 9 and 10, once the connection tube 170 of the lead post 118 engages and elastically snaps into the flexible clip 190 of the frame clip 184, the lead post 118 is releasably connected to the second vertical support 128 thereby enclosing the shower area 1000 (FIG. 1). The user can then take a shower and, when finished, pull back on the handle 134 to disengage the connection tube 170 from the frame clip 184. The bias on the flexible panel 116 may automatically draw, or contribute to draw (with help of the user pulling the handle 134), the lead post 118 away from the second vertical support 128 to open the enclosure system 100. As the lead post 118 moves back along the bottom and top track assemblies 122 and 124, the lead post 118 catches and disengages the support post 120 from the corner stop pin 148 on the lower corner assembly 140 thereby allowing the support post 120 to return to the original position along with the lead post 118 (FIG. 1). As mentioned heretofore, in some embodiments, the user may use the handle 134 to assist and control the movement of the lead post 118 and thus the support post 120 and the flexible panel 116 back to the open original position, with help of the internal bias which tends to wind the flexible panel 116 back into the cartridge assembly 112.

Should the user desire to lock the lead post 118 to the second support post 128 to prevent any inadvertent withdrawal of the flexible panel 116, the user presses down on the finger tab(s) 202 on the upper latch member 180 (FIG. 9) to move the upper latch member 180 down over the upper pin 186 in the frame clip 184 (FIG. 10) to a locked condition. More specifically, the upper latch member 180 is moved down over the upper pin 186 until the upper pin 186 enters the second cavity 206 in the upper latch member 180 to securely lock the lead post 118 to the second vertical support 128. Likewise, the user can gain added security by raising the lower latch member 182 up until the lower pin 188 enters the bore 226 in the second latch member 182 to further lock the lead post to the second vertical support 128 and thus securely lock the flexible panel 116 around the shower area 1000.

As best shown in FIG. 10, in order to unlock the lead post 118 from the second vertical support 128, the process is reversed by raising and lowering the upper and lower latch members 180 and 182, respectively, to release the upper and lower latch members 180 and 182 form the respective upper and lower pins 186 and 188 of the frame clip 184 to the initial unlocked condition (FIG. 9). The lead post 118 can then be pulled free of the frame clip 184 in the manner described hereinabove to withdraw or open the flexible panel 116.

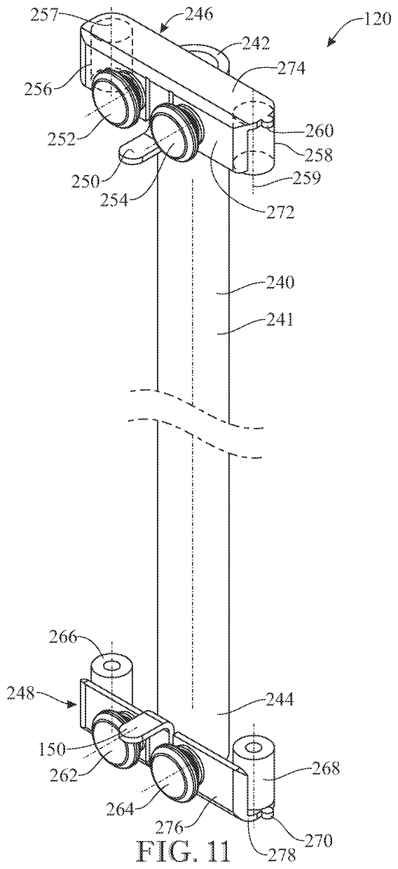

Turning to FIG. 11, the support post 120 generally includes an elongate main body 240 having a top end 242 and a bottom end 244. The elongate main body 240 may be in the form of a bar, tube or profile, which may be solid or hollow. In some embodiments, the main body 240 may have an outer convex or outwardly curved contour at least along a side of the main body 240 which faces the flexible panel 116; the outwardly curved contour may allow the flexible panel 116 to smoothly move over and along the elongate main body 240 with minimal friction and preventing damage to the flexible panel 116. For example, in some preferred embodiments, such as the present embodiment, the main body 240 may be generally cylindrical, as shown. The cylindrical nature of the elongate main body 240 may allow the flexible panel 116 to smoothly move around and along the elongate main body 240 with minimal friction and increasing durability of the flexible panel 116. An upper carriage member 246 may be mounted on the top end 242 of the main body 240 and a lower carriage member 248 may be mounted on the bottom end 244 of the main body 240. In some embodiments, the elongate main body 240 is rotatably connected to the upper and lower carriage members 246 and 248 such that the main body 240 may rotate relative to said carriage members about a central longitudinal axis of the main body 240, allowing the flexible panel 116 to roll on the cylindrical main body 240 as the flexible panel 116 is advanced towards or away from the second vertical support 128, which may further increase durability of the flexible panel 116. In some embodiments, the upper and lower carriage members 246 and 248 may each have an elongated, L-shaped profile configuration. The lower stop bar 150, described hereinabove, may be mounted on, and extend from, the lower carriage member 248. Similarly, the upper carriage member 246 may include an upper stop bar 250 mounted on, and extending from, the upper carriage member 246 for engagement with a similar stop pin 148 on the top corner assembly 146 (FIG. 2). In order to freely move the support post 120 along the upper track assembly 124, the support post 120 includes a pair of upper track rollers 252 and 254 rotatably mounted on the upper carriage member 246.

As noted hereinabove, the displacement of the support post 120 along the bottom and top track assemblies 122 and 124 is stopped or arrested at the corner assemblies 140 and 146 by engagement of the lower and upper stop bars 150 and 250 with the lower and upper stop pins 148 on the lower and upper corner assemblies 140 and 146, respectively. As described heretofore, when the support post 120 is stopped at the corner assemblies 140 and 146, the flexible panel 116 may be drawn past the support post 120 and around the corner as the lead post 118 is detached from the support post 120 and drawn toward the second vertical support post 128.

With continued reference to FIG. 11, the support post 120 includes a pair of vertical side or upper panel rollers 256 and 258 rotatably mounted to the upper carriage member 246. The upper panel rollers 256 and 258 are rotatable about respective rotation axes 257 and 259 which are perpendicular to the direction of displacement of the flexible panel 116; for instance, in the present embodiment, the flexible panel 116 moves horizontally, while the upper panel rollers 256 and 258 are rotatable about respective vertical rotation axes 257 and 259 of the upper panel rollers 256 and 258. The upper panel rollers 256 and 258 are free to rotate relative to the upper carriage member 246 and against the flexible panel 116 as the flexible panel 116 is pulled past the stationary support post 120 and rolls over the upper panel rollers 256 and 258, for purposes that will be described hereinafter.

The upper carriage member 246 may additionally include a projection or connector 260 which is provided to releasably engage the support post 120 with the lead post 118. The connector 260 may be shaped as a laterally-truncated circle or cylinder, as shown, for instance and without limitation. In an initial condition of the lead post 118 and support post 120 relative to one another (FIGS. 1 and 2), the connector 260 of the support post 120 is disconnectably secured within the flexible clip 172 (FIG. 5) formed in the trailing edge 164 of the lead post 118. This connection between the connector 260 and the flexible clip 172 provides an elastic, snap fit connection which secures the support post 120 to the lead post 118 until the movement of the support post 120 along the bottom and top track assemblies 122 and 124 is arrested by the lower and upper stop pins 148 on the bottom and top corner assemblies 140 and 146, respectively. Once the support post 120 is stopped from moving forward, continued pulling on the lead post 118 causes the flexible clip 172 to disconnect from the connector 260 and thereby allow the lead post 118 and flexible panel 116 to progress forward towards the closed condition, as depicted in FIGS. 3 and 4.

Similarly, as further shown in FIG. 11, the lower carriage member 248 may include a pair of lower track rollers 262 and 264 and a pair of vertical side or lower panel rollers 266 and 268 which may rotate, and function, analogously to the upper track rollers 252 and 254 and the upper panel rollers 256 and 258 described hereinabove. The lower carriage member 248 may further include a projection or connector 270 for releasable engagement with the flexible clip 172 on the lead post 118. Providing connectors 260 and 270 on both the upper and lower support plates 246 and 248, respectively, may contribute to prevent canting of the support post 120 as the support post 120 is disengaged from the lead post 118.

With continued reference to FIG. 11, the upper carriage member 246 may include a vertical plate or portion 272 and a horizontal plate or portion 274 forming an L-shaped arrangement with one another, with the vertical portion 272 arranged on an outer side of the elongate main body 240 configured to face the flexible panel 116, and the horizontal portion 274 arranged past the top end of the elongate main body 240. Similarly, the lower carriage member 248 may include a vertical plate or portion 276 and a horizontal plate or portion 278 forming an L-shaped arrangement with one another, with the vertical portion 276 arranged on a same side of the elongate main body 240 as the vertical portion 272 of the upper carriage member 246, and the horizontal portion 278 arranged past the bottom end of the elongate main body 240. The pair of upper track rollers 252 and 254 are rotatably mounted on the vertical portion 272 of the upper carriage member 246, protruding from an outer side of the vertical portion 272. The pair of upper panel rollers 256 and 258 are rotatably mounted on the horizontal portion 274 of the upper carriage member 246, protruding downward from an inner side or underside of the horizontal portion 274. Similarly, the pair of lower track rollers 262 and 264 are rotatably mounted on the vertical portion 276 of the lower carriage member 248, protruding from an outer side of the vertical portion 276. The pair of lower panel rollers 266 and 268 are rotatably mounted on the horizontal portion 278 of the lower carriage member 248, protruding upward from an inner side or top side of the horizontal portion 278.

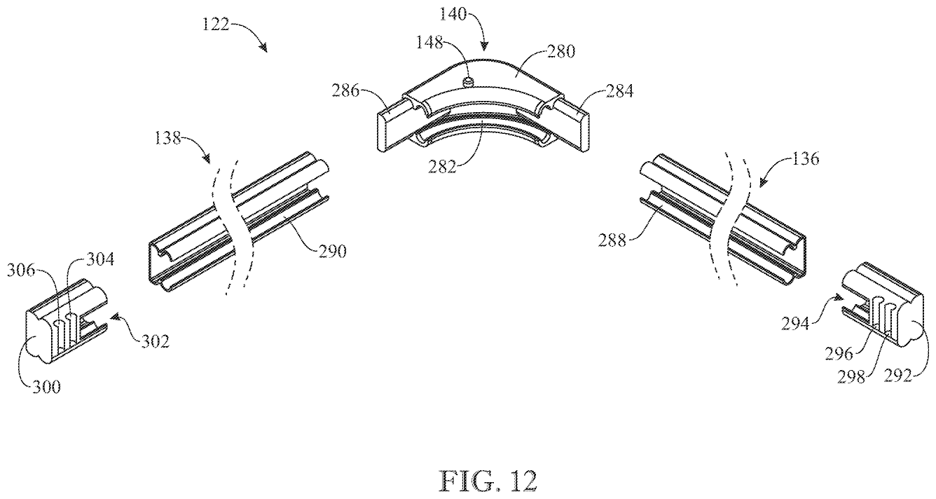

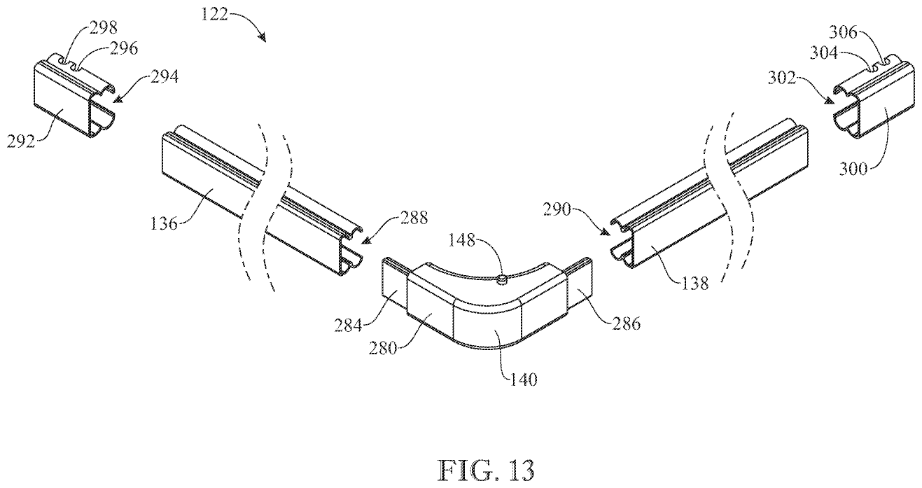

Turning to FIGS. 12 and 13, the details of the bottom track assembly 122 will now be described. It should be noted that, as mentioned heretofore, the top track assembly 124 may be substantially identical and may differ only in that the stop pin 148 on the corner assembly 146 of the top track assembly 124 faces downward to engage the stop bar 250 on the upper carriage member 246 of the support post 120. As noted hereinabove, the bottom track assembly 122 may generally include the first linear track assembly 136, the second linear track assembly 138 and the corner assembly 140, which interconnects the first and second linear track assemblies 136 and 138 at an angle such as 90 degrees with one another. The stop pin 148 protrudes upward from a top side of the corner assembly 140.

The corner assembly 140 includes a corner body portion 280, defining a curved channel 282, and a pair of connectors 284 and 286. The connectors 284 and 286 extend outward from opposite ends of the corner body portion 280 in different directions (e.g., perpendicularly) relative to one another. The first linear track assembly 136 comprises a channel 288, and the second linear track assembly 138 comprises a channel 290. The corner assembly 140 is connected to the first linear track assembly 136 by inserting the connector 284 of the corner assembly 140 into the channel 282 of the corner assembly 140 and into the channel 288 of the first linear track assembly 136. Similarly, the corner assembly 140 is connected to the second linear track assembly 138 by inserting the connector 286 into the channel 282 of the corner assembly 140 and the channel 290 in the second linear track assembly. In some embodiments, the connector 284 and/or 286 may come pre-assembled or integrally-formed with the corner assembly 140 or with the first or second linear track assemblies 136 and 138, respectively. Connecting the connectors 284 and 286 causes the channel 282 of the corner assembly 140 to align with the channels 288 and 290 defined in the first and second linear track assemblies 136 and 138 in continuity with one another to allow the lower roller 176 of the lead post 118 to pass from the first linear track assembly 136, through and around the corner assembly 140 and into the second linear track assembly 138 as described hereinbelow.

As mentioned heretofore, in some embodiments, the bottom track assembly 122 and/or the top track assembly 124 may be length-adjustable. For example, the bottom track assembly 122 and/or the top track assembly 124 may be comprised of two or more track segments which are telescopically adjustable relative to each other to vary the overall length of the bottom track assembly 122 and/or the top track assembly 124. With specific reference, for instance, to FIG. 12, in some embodiments, the first linear track assembly 136 and/or the second linear track assembly 138 may be made of two or more linear track segments which are telescopically connected and adjustable relative to one another to vary the overall length of the first and/or second linear track assembly 136, 138 and thereby allow the frame 114 (FIG. 1) to be adjusted to accommodate differently-sized shower areas 1000.

As further shown in FIGS. 12 and 13, the bottom track assembly 122 may include an end piece 292 defining a channel 294 for receipt of the first linear track assembly 136. The end piece 292 may be fixedly connected to the first linear track assembly 136 or may be slidably mounted thereto to allow for adjustment of the length of the combined first linear track assembly 136 and end piece 292 to further accommodate various size shower areas 1000. In some embodiments, the end piece 292 may include a pair of elastic clips 296 and 298 for disconnectable connection to mating projections on the first vertical support 126 to easily, rapidly and disconnectably connect the bottom track assembly 122 to the first vertical support 126. Similarly, the bottom track assembly 122 may include an additional end piece 300 defining a channel 302 for receipt of the second linear track assembly 138 and/or a pair of elastic clips 304 and 306 for rapidly, easily and disconnectably connecting the bottom track assembly 122 to the second vertical support 128.

In some embodiments, such as the present embodiment, the first and second linear track assemblies 136 and 138 may be compatible for mounting to both connectors 284 and 286 of the bottom corner assembly 140 and to both end pieces 292, 300 on either side of the bottom corner assembly 140. In some embodiments, the connectors 284, 286 may be generally the same. Alternatively or additionally, the end pieces 292, 300 may be generally the same.

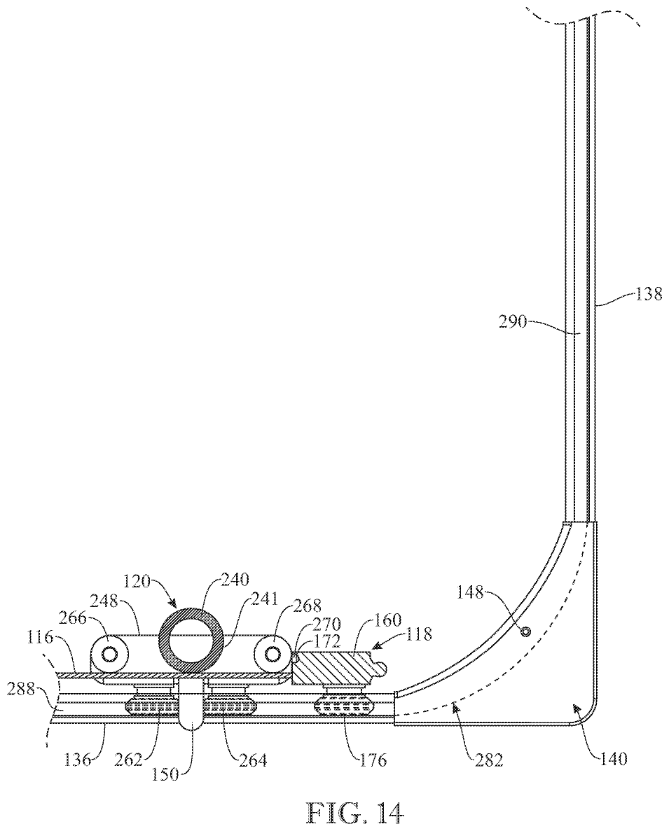

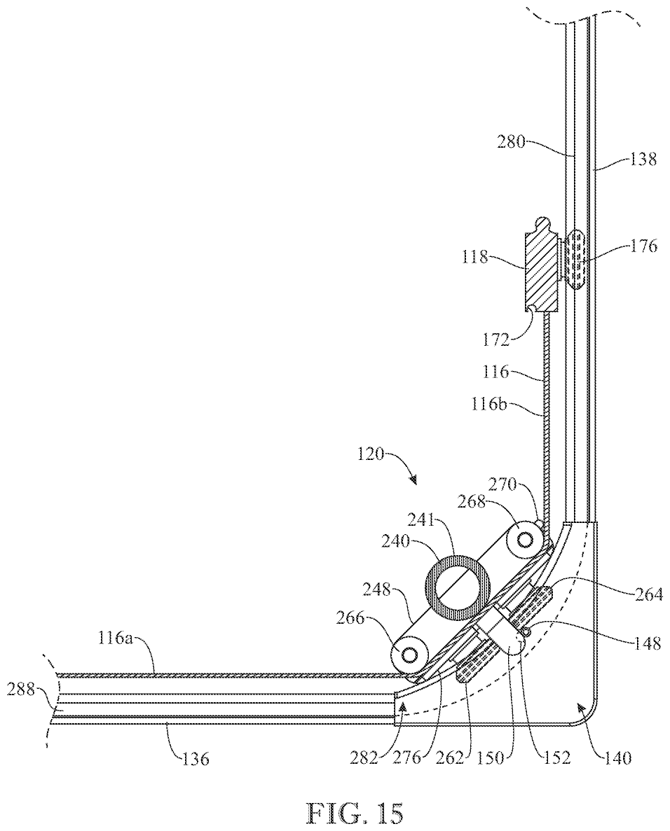

Turning to FIGS. 14 and 15, the movement of the lead post 118, the support post 120 and the flexible panel 116 along the bottom track assembly 122 will now be described. The movement along the top track assembly 124 is substantially identical and will not be further described. Initially, as shown in FIG. 14, the support post 120 is connected to the lead post 118 by the disconnectable connection between the connector 270 and flexible clip 172, in the manner described hereinabove. The lower roller 176 of the lead post 118 and the lower track rollers 262 and 264 of the support post 120 are located within the channel 288 in the first linear track assembly 136 of the bottom track assembly 122. The flexible panel 116 is attached to the lead post 118 and is positioned against the lower panel rollers 266 and 268 of the support post 120 and against an outer surface 241 of the main body 240 of the support post 120. Sufficient pulling of the lead post 118 eventually causes the lead post 118 to be moved into the corner such that the lower roller 176 of the lead post 118 passes into the channel 282 in the corner assembly 140 (FIG. 12).

With specific reference to FIG. 15, continued pulling of the lead post 118 pulls on the flexible panel 116 and support post 120 and eventually causes the lower carriage member 248 of the support post 120 to reach the corner assembly 140, and the lower track rollers 262 and 264 to move from the channel 288 in the first linear track assembly 136 and into the channel 282 in the corner assembly 140. Eventually, as shown in the figure, the stop bar 150 on the support post 120 engages the stop pin 148 on the corner assembly 140, blocking further forward movement of the support post 120 along the corner assembly 140 and towards the second vertical support 128 (FIG. 3). In some embodiments, the stop bar 150 may include an indentation or space 152 (shown in phantom lines in FIG. 15) configured to receive, and optionally elastically clip to, the stop pin 148 when the stop bar 150 abuts against the stop pin 148, further contributing to stabilize the support post 120 in this stopped condition at the corner assembly 140. Once the support post 120 is stopped, continued pulling of the lead post 118 along the corner assembly 140 and the second linear track assembly 138 disengages the connectors 260, 270 (FIG. 11) of the support post 120 from the flexible clips 172 (FIG. 5) on the lead post 118, causing the lead post 118 to become detached from the support post 120. Further pulling of the lead post 118 then slides the lead post 118 along the second linear track assembly 138, causing the lead post 118 to draw the flexible panel 116 around the support post 120.

As best shown in FIG. 15, as the flexible panel 116 moves forward with the lead post 118, the flexible panel 116 may advance between and relative to the lower panel rollers 266, 268 and the vertical portion 276 of the lower carriage member 248, and may roll smoothly against and on the lower panel rollers 266 and 268 of the support post 120. In some embodiments, the flexible panel 116 may ride along the outer surface 241 of the elongate main body 240 of the support post 120 along most of or substantially the entire length of the main body 240. Thus, the provision of the support post 120, whose movement is arrested at the corner assembly 140, serves to guide the flexible panel 116 around the corner while supporting the flexible panel 116 at the corner to prevent the flexible panel 116 from collapsing inward at the corner assembly 140. Once the flexible panel 116 reaches the closed condition (FIG. 4), the flexible panel 116, which may or may not be perfectly tense in the area of the support post 120 and corner assembly 140, is prevented from sagging inward by the adjacent support post 120 extending vertically along the flexible panel 116.

Notably, the lower track rollers 262 and 264 of the support post 120 are separated from one another a relatively small distance which allows the lower track rollers 262 and 264 to roll smoothly into and along the curved, inner track 282 of the corner assembly 140. In turn, the lower panel rollers 266 and 268 are more spaced apart with one another than the lower track rollers 262 and 264, and positioned such that the lower panel rollers 266 and 268 maintain first and second areas or portions 116a and 116b of the flexible panel 116, located at opposite sides of the corner area, parallel to the first and second linear track assemblies 136 and 138, respectively, to maintain an aesthetically pleasing orientation of the flexible panel 118 at either side of the corner assembly 140, as best shown in FIGS. 3, 4 and 15.

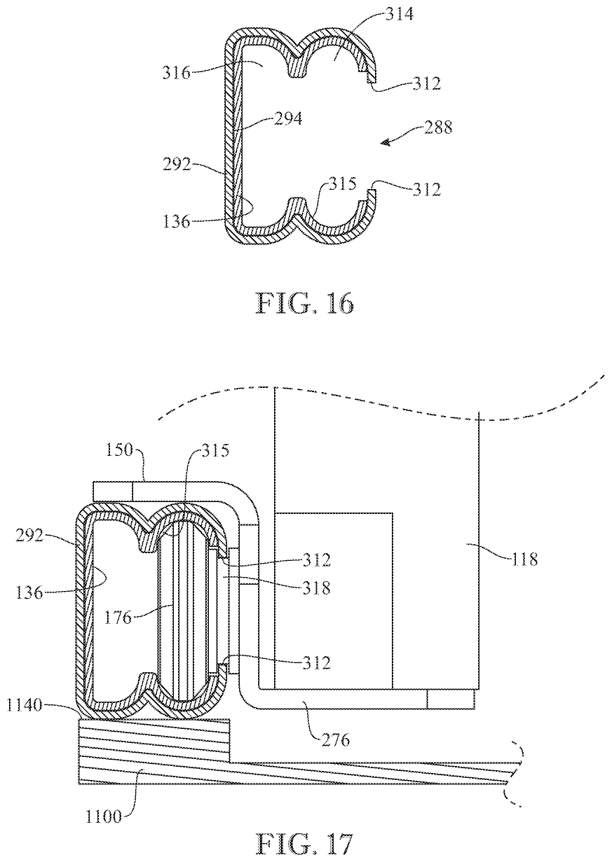

Referring now to FIGS. 16 and 17, at least one of the bottom, first and second linear track assemblies 136 and 138, and also the top, first and second linear track assemblies 142 and 144, may be formed of two or more telescopically-interconnected parts and/or may be telescopically formed with the end pieces 292 and 300. Details of these telescopic arrangements are shown in FIG. 16, with reference for instance to the first linear track assembly 136 and the channel 294 of the end piece 292, wherein said details are equally applicable to any additional or alternative telescopic connections within each linear track assembly 136, 138, 140, 144 or between each linear track assembly and the end piece (e.g., end pieces 292, 300) at the top or bottom of the frame 114. As shown, the telescopically-connected parts may be nested within one another; for instance, the first linear track assembly 136 may be nested within the channel 294 of the end piece 292. Sliding the telescopically-connected parts relative to one another, i.e. the end piece 292 relative to the first linear track assembly 136, allows the user to adjust the length of the bottom track assembly 122 (FIG. 1) to suit the shower area 1000. Additionally, in cross section, the various disclosed channels may have two sections or parts. For example, with regard to the channel 288 of the first linear track assembly 136, the channel 288 may have an outer or first channel area 314 to accommodate the disclosed rollers and an inner or second channel area 316 to allow for the connectors 284 and/or 286 of the corner assembly 140. The first and second channel areas 314 and 316 may be arranged generally parallel to one another. The second channel area 316 may extend along all or part of the length of the first linear track assembly 136; for instance, in the present embodiment, both the first and the second channel areas 314 and 316 extend along the entire length of the first linear track assembly 136.

With regard to FIG. 17, in the case of the nested first linear track assembly 136 and the end piece 292, the lower roller 176 of the lead post 118, and the lower track rollers 262 and 264 of the support post 120 (which are in alignment with the lower roller 176 of the lead post 118) ride in the combined first linear track assembly 136 and the end piece 292. For example, with regard to the lower roller 176 of the lead post 118, the lower roller 176 rides in and along the first channel area 314 of the first linear track assembly 136, contacting internal walls 315 defining the first channel area 314; in addition, a collared shaft portion 318 of the lower roller 176 rolls on a lip or rim 312 of the end piece 292. This arrangement of the lower roller 176 contacting both the inner telescopic part (e.g., first linear track assembly 136) and the outer telescopic part (e.g., end piece 292) ensures the lower roller 176 rides smoothly along the bottom track assembly 122.

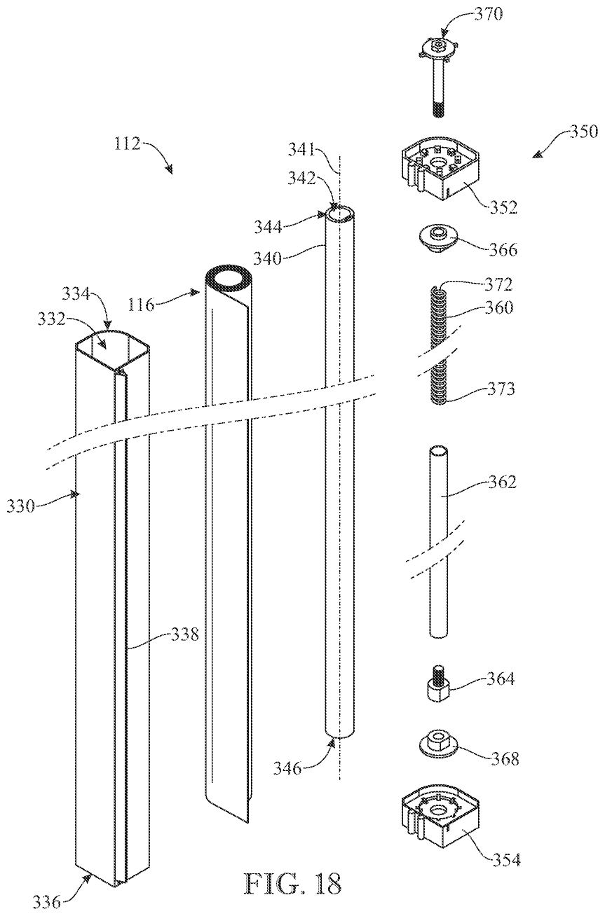

Turning now to FIGS. 18-29, and initially with regard to FIG. 18, the details of the cartridge assembly 112 will now be described. As noted hereinabove, the cartridge assembly 112 is provided to be releasably attached to the frame 114 and retain the flexible panel 116 under tension so that the flexible panel 116 is biased into retraction within the cartridge assembly 112 when not in use. The cartridge assembly 112 may include an outer shell 330 having an interior space 332, which may extend along the entire length of the outer shell 330. The outer shell 330 may have an open top end 334 and an open bottom end 336 in spatial communication with the interior space 332. The outer shell 330 may include a longitudinally extending panel slot 338 for passage of the flexible panel 116 into and out of the cartridge assembly 112.

The cartridge assembly 112 may further include a drum 340 positioned within the outer shell 330 and about which the flexible panel 116 is wound. The drum 340 may include an interior space 342, which may extend through the entire length of the drum 340, and open top and bottom ends 344 and 346 in spatial communication with the interior space 342. The interior space 342 may have a non-circular transverse cross-section at least in the area of the top and bottom ends 344 and 346, and more preferably along the entire length of the drum 340. For instance, in the disclosed embodiment, the non-circular interior space 342 of the drum has a generally D-shaped transverse cross-section. While the disclosed interior space 342 is D-shaped, other non-circular shapes are contemplated, such as, but not limited to, rectangular, oval, lobed, etc. The drum 340 may be positioned within the outer shell 330 as described in more detail hereinbelow.

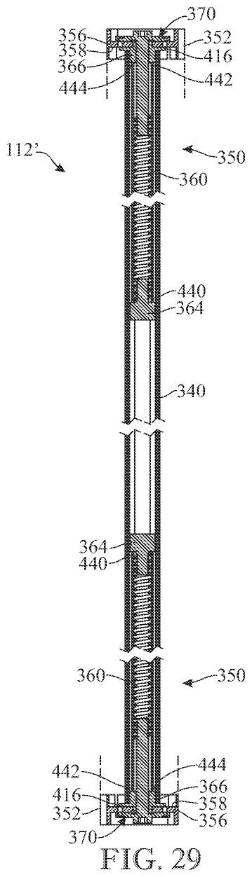

In order to bias the flexible panel 116 into the cartridge assembly 112, the cartridge assembly may include a tensioning mechanism 350 connected to the drum 340 and positioned within the interior space 342 of the drum 340. It should be noted that, while the illustrations of FIGS. 18-28 show an embodiment of the cartridge assembly 112 including a single tensioning mechanism 350 at the top of the cartridge assembly 112, further embodiments are contemplated in which the cartridge assembly 112 may alternatively or additionally include a similar tensioning mechanism 350 at the bottom of the cartridge assembly 112. For instance, in a particularly advantageous embodiment, shown in FIG. 29, a cartridge assembly 112′ is shown including two tensioning mechanisms 350, respectively arranged at top and bottom ends of the cartridge assembly 112. It should be noted that, unless expressed otherwise, details of the top tensioning mechanism 350 described with reference to the embodiment of FIGS. 18-28 may be symmetrically provided in the bottom tensioning mechanism 350.

With continued reference to FIG. 18, a top shell cover 352 may close off the open top end 334 of the outer shell 330 and a bottom shell cover 354 may close off the open bottom end 336 of the outer shell 330 to retain the flexible panel 116, the drum 340 and the tensioning mechanism 350 within the interior space 332 of the outer shell 330.

As further shown in FIG. 18, the tensioning mechanism 350 may include a biasing spring 360, which provides a torsion spring function configured to bias the flexible panel 116 into the cartridge assembly 112 by tensioning or loading the drum 340 for rotation within, and relative to, the outer shell 330, and about a central longitudinal axis 341 of the drum 340. The biasing spring 360 may also function indirectly as an extension (or pulling) spring for purposes that will be described hereinafter. The biasing spring 360 is positioned within and extends along an inner tube 362 of the tensioning mechanism 350. The inner tube 362 is freely movable inside the drum and freely slides up and down within the drum 340 as the biasing spring 360 it tensioned and relaxed, as will be described in greater detail hereinafter. The tensioning mechanism 350 may further include a bottom spring connector 364 secured to a bottom end 373 of the biasing spring 360 at a bottom end of the inner tube 362, wherein the bottom spring connector 364 (and thus the bottom end of the biasing spring 360) is slidable within and non-rotatable relative to the drum 340. A top cap 366 may close off the open top end 344 of the drum 340 and a bottom cap 368 may close off the open bottom end 346 of the drum 340. The top cap 366 and the bottom cap 368 are non-rotationally connected to the drum 340 and rotate jointly with the drum 340 within the outer shell 330. With reference to FIG. 29, it should be noted that, in embodiments including both top and bottom tensioning mechanisms 350, the top and bottom biasing springs 360 may be symmetrical to one another such that the springs 360 provide a spring-loading effect in the same angular direction and thus cooperate in spring-loading the cartridge assembly 112.

Referring again to FIG. 18, the tensioning mechanism 350 may further include a spring tension adjustment rod 370, which allows an operator to pre-set the tension on the biasing spring 360, or change the tension on the biasing spring 360 during or after installation of the cartridge assembly 112 in the enclosure system 100. The adjustment rod 370 may extend through the top shell cover 352 of the outer shell 330 and the top cap 366 of the drum 340 and engage a top end 372 of the biasing spring 360 such that the adjustment rod 370 and top end 372 of the biasing spring 360 are jointly rotatable. Rotation of the adjustment rod 370 relative to the drum 340 tensions the biasing spring 360 within the drum 340 as discussed hereinbelow.

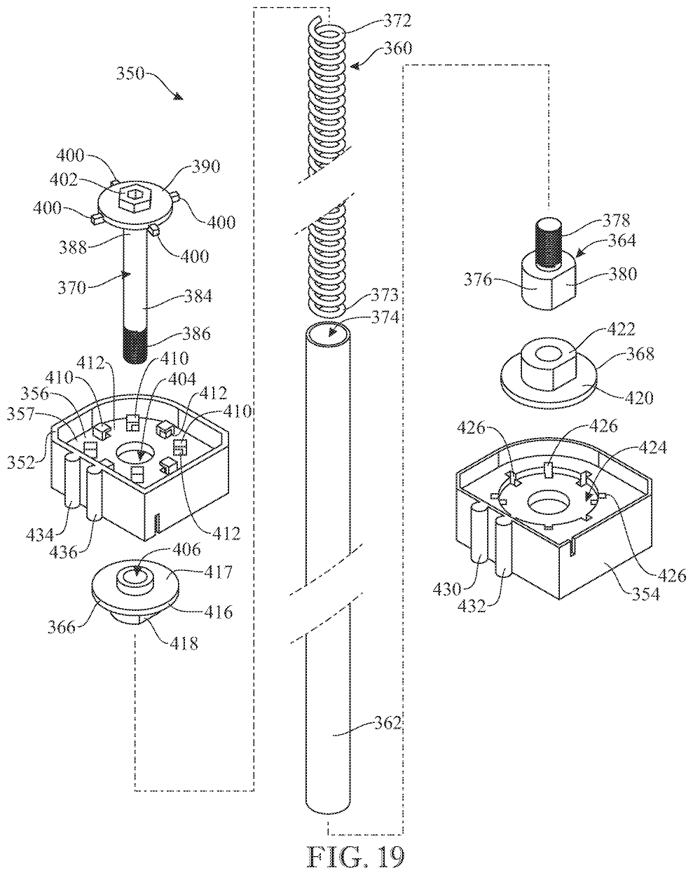

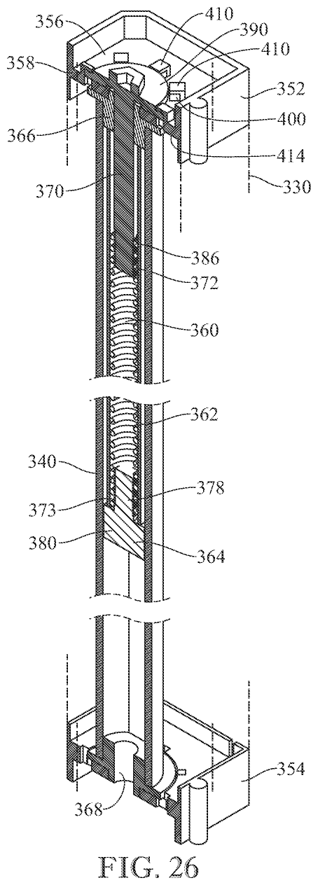

Referring now to FIGS. 19 and 26, the biasing spring 360 is received within a through cavity or interior space 374 of the inner tube 362. The bottom spring connector 364 includes a non-circular base 376 and a threaded shaft 378 extending upward from the base 376. In this embodiment, the non-circular base 376 is shaped as a laterally truncated cylinder (i.e. has a D-shaped transverse cross-section) having a flat side 380. The shape of the non-circular base 376 conforms to the shape of the non-circular interior space 342 (FIG. 18) of the drum 340 such that the base 376 jointly rotates with the drum 340 and is free to slide up and down within the interior space 342 in the drum 340 as the biasing spring 360 expands and contracts. The threaded shaft 378 of the bottom spring connector 364 is threaded into the bottom end 373 of the biasing spring 360 to secure the bottom spring connector 364 to the biasing spring 360.

As noted hereinabove, the top end 372 of the biasing spring 360 is connected to the tension adjustment rod 370. The tension adjustment rod 370 generally includes an elongate adjustment shaft 384 having a threaded bottom end 386. The threaded bottom end 386 of the adjustment shaft 384 is threaded into the top end 372 of the biasing spring 360 to secure the tension adjustment rod 370 to the biasing spring 360. Rotation of the tension adjustment rod 370 rotates the biasing spring 360 within the drum 340. A top end 388 of the adjustment shaft 384 is connected to a circular locking adjustment flange 390 having one or more (and preferably a plurality of) locking arms 400 extending radially outwardly from the adjustment flange 390. A torque-applying connector 402 (e.g., a hexagonal male and/or female connector), is affixed to or provided on the adjustment flange 390 to facilitate rotating the tension adjustment rod 370 as described hereinbelow.

As noted above, the tension adjustment rod 370 passes through the top shell cover 352 and the top cap 366 of the drum 340. Specifically, the adjustment shaft 384 of the tension adjustment rod 370 passes through a bore or hole 404 in the top shell cover 352 and a bore or hole 406 in the top cap 366 of the drum 340. The tension adjustment rod 370 may be pulled up vertically relative to the top shell cover 352 to allow the tension adjustment rod 370 to be rotated, in order to rotate the top end 372 of the biasing spring 360 relative to the bottom end 373 of the biasing spring 360. In order to secure the position of the tension adjustment rod 370 and thus the top end 372 of the biasing spring 360 after rotational adjustment, an upper surface 357 of a transverse, cover wall 356 of the top shell cover 352 is provided with a plurality of stops 410. The stops 410 may include recesses 412 for receipt of the locking arm or arms 400 of the tension adjustment rod 370.

With continued reference to FIGS. 19 and 26, the top cap 366 of the drum 340 may be configured to frictionally engage an underside 414 of the top shell cover 352 (FIG. 26) when the flexible panel 116 is being retracted into the cartridge assembly 112, softening the retraction and preventing the flexible panel 116 from slamming or whipping back into the cartridge assembly 112. Specifically, the top cap 366 may include a circular flange 416 and a non-circular (e.g., D-shaped) shaft 418 extending from the circular flange 416. An external, braking surface 417 of the circular flange 416 may engage the top shell cover 352 while the non-circular shaft 418 is secured within the top end 344 of the drum 340 and the non-circular shaft 418 rotates with the drum 340 due to the corresponding engagement with the non-circular interior space 342 of the drum 340 (FIG. 18). Likewise, the bottom cap 368 of the drum 340 also includes a circular flange 420 and a non-circular shaft 422. The circular flange 420 may rotate freely relative to the bottom shell cover 354 (e.g., within a recess 424 in the bottom shell cover 354), while the non-circular shaft 422 is non-rotationally received within the interior space 342 of the drum 340. In some embodiments, the bottom shell cover 354 may be provided with a plurality of drain slots 426 to allow any moisture on the flexible panel 116 to drain out of the cartridge assembly 112. Furthermore, the bottom shell cover 354 may include a pair of projections 430 and 432 which engage the elastic clips 296 and 298 in the end piece 292 to removably secure the bottom end of the cartridge assembly 112 to the frame 114. Similarly, the top shell cover 352 may include a pair of projections 434 and 436 which engage similar elastic clips in a top end piece of the frame 114, to removably secure a top end of the cartridge assembly 112 to the frame 114.

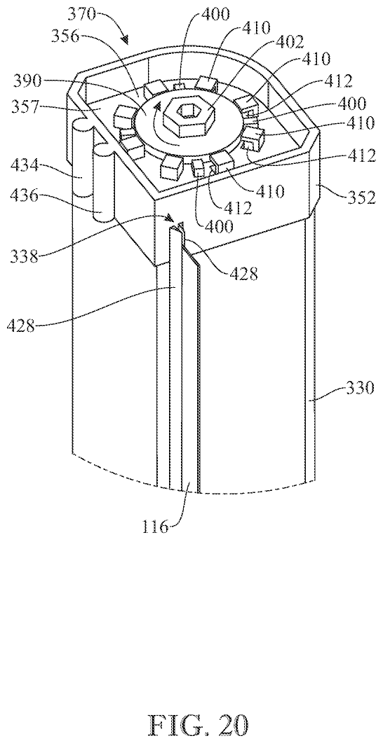

With reference to FIG. 20, in some embodiments, the outer shell 330 may be provided with a pair of wipers 428 at opposite sides of the slot 338 and along the slot 338 through which the flexible panel 116 enters and exits the cartridge assembly 112. The wipers 428 serve to wipe off excess water from the flexible panel 116 as the flexible panel 116 is retracted back into the cartridge assembly 112 after use. The wipers 428 may be elastic, and made, for instance and without limitation, of rubber or silicone.

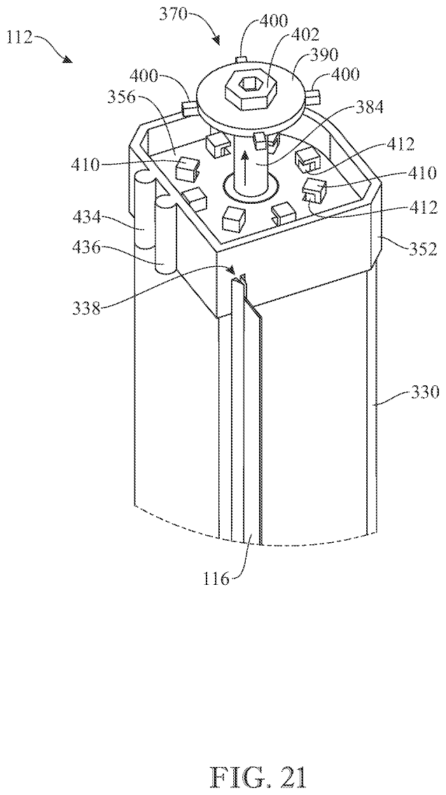

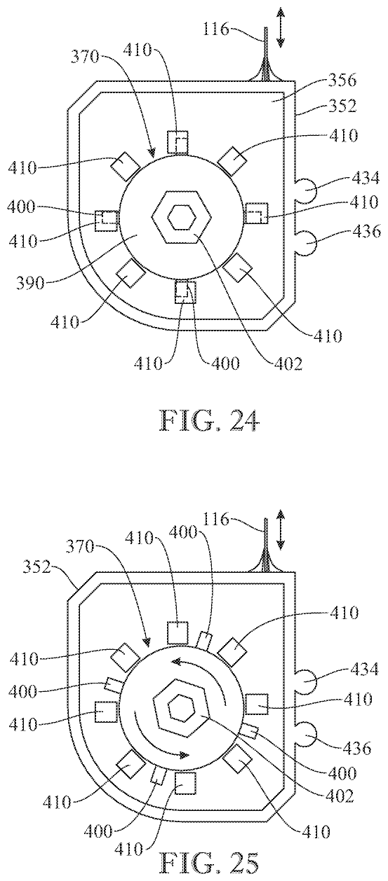

Turning to FIGS. 20-25, the operation of the tensioning mechanism 150 to pre-tension the flexible panel 116 within the drum 340 will now be described. As best shown in FIGS. 24 and 26, in the initial condition prior to adjustment of the tension of the tension spring 360, the plurality of locking arms 400 extending from the adjustment flange 390 of the tension adjustment rod 370 are locked or secured to the top shell cover 352. Specifically, the plurality of locking arms 400 are positioned within the recesses 412 (FIG. 21) of the stops 410 on the top shell cover 352. It should be noted that, in embodiments including both top and bottom tensioning mechanisms 350 (e.g., the embodiment of FIG. 29), the respective recesses 412 may be symmetrically formed such that the respective locking arms 400 are engaged with the recesses 412 in the same angular direction.

As best shown in FIGS. 20 and 25, in order to unlock the tension adjustment rod 370 from the top shell cover 352, an operator engages the torque-applying connector 402 with a torque-applying tool such as, but not limited to, wrench, pliers, or s screwdriver, and applies a torque on the torque-applying connector 402 to cause the tension adjustment rod 370 to rotate. The operator then proceeds to rotate the tension adjustment rod 370 such that the plurality of locking arms 400 are moved out of the recesses 412 in the stops 410.

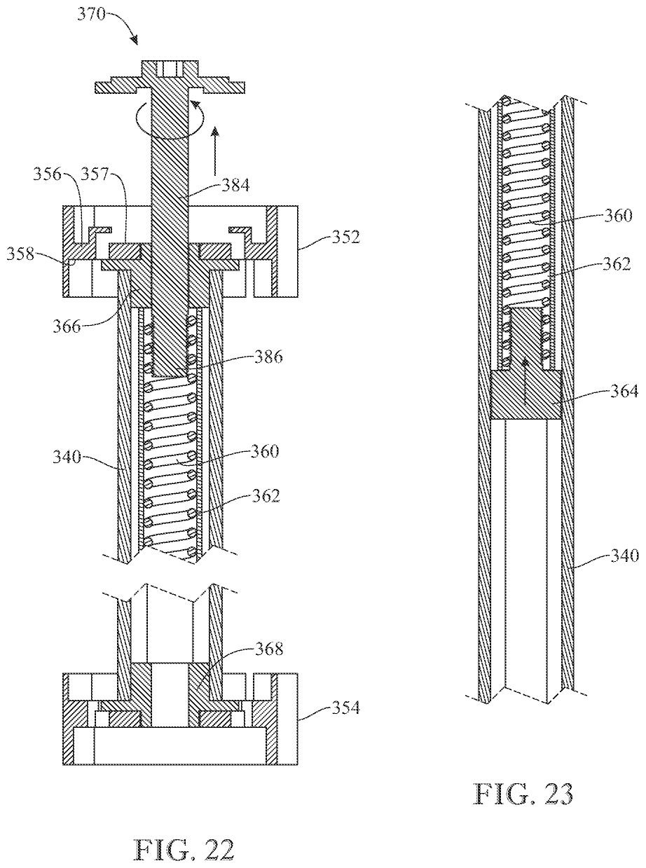

Referring now to FIGS. 21 and 22, once the tension adjustment rod 370 has been unlocked from the top shell cover 352, the tension adjustment rod 370 is free to move axially relative to the top shell cover 352, and can be raised by the operator to position the plurality of locking arms 400 out of alignment with the stops 410 on the top shell cover 352. Thus, the tension adjustment rod 370 is now in an elevated and unlocked position in which the tension adjustment rod 370 can be rotated with no interference by the stops 410 on the top shell cover 352.

With continued reference to FIGS. 21 and 22, in order to pre-set or adjust the tension on the biasing spring 360, and thus pre-set or adjust the retraction bias on the flexible panel 116, the user rotates the tension adjustment rod 370 relative to the top shell cover 352. In order to further load the biasing spring 360, the operator rotates the tension adjustment rod 370 away from the recesses 412 (clockwise in the depicted example); if, instead, the user wishes to reduce the spring tension (unload the spring), the user rotates the tension adjustment rod 370 towards the recesses 412 (counterclockwise in the depicted example). As the bottom spring connector 364 is prevented from rotation within the drum 340 due to the non-rotational engagement between the bottom spring connector 364 and the interior space 342 of the drum 340 as described above but is free to slide longitudinal within the interior space 342 of the drum 340, rotation of the top end of the biasing spring 360 causes the spring tension to change. It must be noted that, as the biasing spring 360 is unloaded, the biasing spring 360 compresses axially, drawing the bottom spring connector 364 upward within the drum 340, the bottom spring connector 364 in turn pushing and carrying the inner tube 362 upward; conversely, as the biasing spring 360 is loaded, the biasing spring 360 extends axially, pushing the bottom spring connector 364 downward within the drum 340, and allowing the inner tube 362 to descend due to gravity.

With reference to FIG. 26, it should be noted that two separate rotatable “groups” are formed within the cartridge assembly 112. The first group includes the drum 340 and the top and bottom caps 366, 368, which jointly rotate within the assembled outer shell 330 (shown in phantom lines) and the top and bottom shell covers 352 and 354. The second group includes the bottom end 373 of the biasing spring 360 and the bottom spring connector 364, both of which are rotated jointly by the drum 340 as the flexible panel 116 is extended from and retracted back into the cartridge assembly 112. In some embodiments, the inner tube 362 may also form part of this second group and jointly rotate with the bottom end 373 of the biasing spring 360 and the bottom spring connector 364. The top end 372 of the biasing spring 360 and the tensioning adjustment rod 370, affixed to the top shell cover 352, do not rotate with the drum 340 as the flexible panel 116 is extended from and retracted back into the cartridge assembly 112.

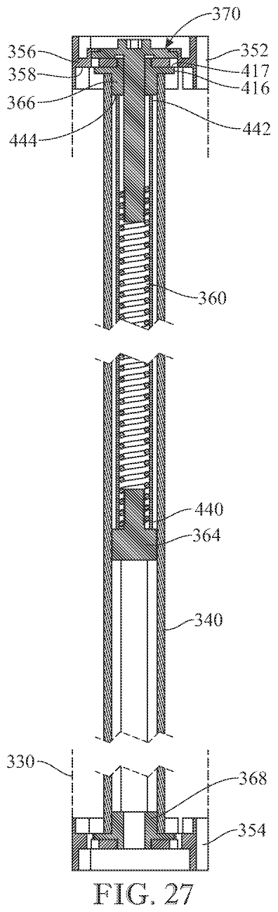

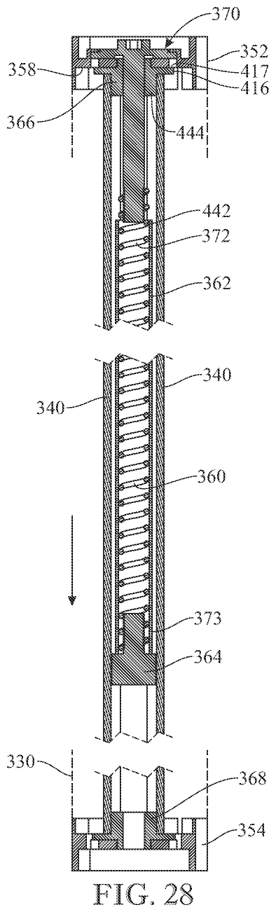

The illustrations of FIGS. 27 and 28 show the sequence of operation of the cartridge assembly 112 as the flexible panel 116 is extended out of the cartridge assembly 112. As shown in FIG. 27, when the flexible panel 116 is arranged inside the outer shell 330 and has not yet been pulled out therefrom, the biasing spring 360 is in an initial condition within the drum 340 and the outer shell 330. In this condition, the biasing spring 360, inner tube 362 and the bottom spring connector 364 are in an initial position within the drum 340. Furthermore, in this initial condition, the biasing spring 360 is slightly extended such that the biasing spring 360 (operating as an extension spring) pulls on the bottom spring connector 364, which in turn exerts an upward force on a bottom end 440 of the inner tube 362, in turn causing a top end 442 of the inner tube to exert an upward force on an underside 444 of the top cap 366 of the drum 340. The upward force on the underside 444 of the top cap 366 causes the braking surface 417 of the circular flange 416 of the top cap 366 to press against an underside 358 of the cover wall 356 of the top shell cover 352 (said underside 358 arranged opposite to the upper surface 357 of the cover wall 356). Thus, in this initial position, while the first rotatable “group” (drum 340 and top and bottom caps 366, 368) is rotatable relative to the outer shell 330, there exists, however, a relatively high friction between this first rotatable “group” and the top shell cover 352 via the braking surface 417 of the circular flange 416 pressing against the underside 358 of the top shell cover 352.

From this initial position of FIG. 27, a user wishing to take a shower, for instance, may start to extend the flexible panel 116 out of the cartridge assembly 112 (FIG. 1) by pulling on the handle 134 as described heretofore in order to form an enclosure. Pulling of the flexible panel 116 causes the drum 340, to which the flexible panel 116 is attached and wound around, to begin rotating within the outer shell 330. Rotation of the drum 340 is facilitated by the rotatable connection of the top cap 366 of the drum 340 to the top shell cover 352 of the outer shell 330 and the rotatable connection of the bottom cap 368 of the drum 340 to the bottom shell cover 354 of the outer shell 330.

As the drum 340 rotates during the extension of the flexible panel 116 out of the cartridge assembly, the drum 340 rotates the bottom spring connector 364, and thus the bottom end 373 of the biasing spring 360, while the top end 372 of the biasing spring 360 remains non-rotatable by its engagement with the locked tensioning adjustment rod 370. Rotation of the bottom end 373 relative to the top end 372 of the biasing spring 360 causes the biasing spring 360 to torsionally load or tension. As the drum 340 rotates, the biasing spring 360 becomes further torsionally tensioned within the drum 340. Due to the increased torsional load, the biasing spring 360 (which was initially slightly extended) further extends or elongates within the drum 340, and thus progressively reduces its pulling force on the bottom spring connector 364. As the biasing spring 360 torsionally loads and axially extends, the bottom spring connector 364, along with the inner tube 362, slide downward within the drum 340, thereby progressively reducing the friction between the braking surface 417 of the circular flange 416 and the top shell cover 352, making gradually easier for the drum 340 to rotate and the flexible panel 116 to be pulled further outward. As the flexible panel 116 is extended out of the cartridge assembly 112 and rotates the drum 340, the biasing spring 360 is torsionally tensioned and also further axially extended relative to the initial condition of FIG. 27.

In the final, closed position of the flexible panel 116 (FIG. 4), the inner tube 362 may be separated from the top cap 366 due to gravity and may rest on the bottom spring connector 364, which in turn is arranged in a lowered condition by the axial expansion of the biasing spring 360. In this final position, the friction (if any) between the braking surface 417 of the circular flange 416 of the top cap 366 and the underside 358 of the top shell cover 352 is substantially less than the friction in the initial condition of FIG. 27. As has been described heretofore, the user may secure the flexible panel 116 in the closed condition by operating the latch assembly 130 (FIG. 5) to the closed condition (FIG. 10).

When the user has finished showering and wishes to exit the shower area 1000, the user may operate the latch assembly 130 to the open condition (FIG. 9) and pull/push on the handle 134 to initiate displacement of the flexible panel 116 towards the open position (FIG. 1). As the flexible panel 116 is pulled back, an inverse sequence of steps takes place within the cartridge assembly 112. The tensioning mechanism 150, and more specifically, the torsionally-loaded biasing spring 360 rotates the drum 340 in an opposite, winding direction and pulls the flexible panel 116 back into the cartridge assembly 112. Notably, as the biasing spring 360 rotates the drum 340 in the winding direction to assist in retracting the flexible panel 116 back into the cartridge assembly 112, the biasing spring 360 contracts within the drum 340 and pulls on the bottom spring connector 364 upwards, causing the bottom spring connector 364 to slide upward within the drum 340 with the bottom end 373 of the biasing spring 360. As the bottom spring connector 364 rises, the bottom spring connector 364 eventually drives the inner tube 362 back up into engagement with the top cap 366 of the drum 340, forcing the inner tube 362 back into engagement with the underside 444 of the top cap 366 and thus to once more push upward on the top cap 366. Continued rotation of the drum 340 causes said upward pushing force of the inner tube 362 on the top cap 366 to gradually increase, which in turn produces a gradually increasing friction between the braking surface 417 of the circular flange 416 of the top cap 366 and the top shell cover 352. This gradually-increasing friction produces a dampening effect on the rotation of the drum 340, thereby controlling speed and acceleration of the drum 340 and flexible panel 116 as the tensioning mechanism 150 retracts the flexible panel 116 back into the cartridge assembly 112. This frictionally aided retraction prevents the flexible panel 116 from whipping back into the cartridge assembly 112, thus providing a more satisfying usage experience to the user as well as increases durability of the enclosure system 100.

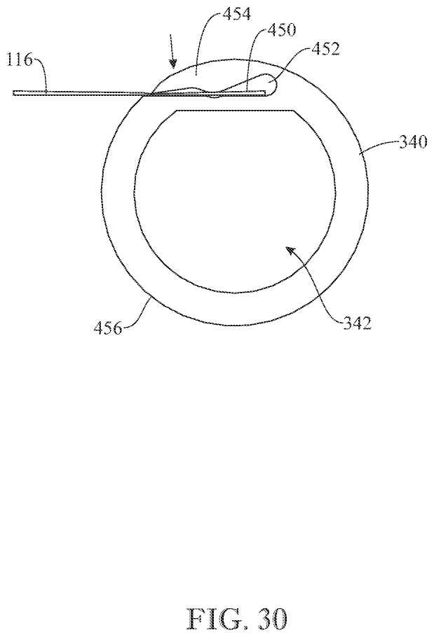

Turning now to FIG. 30, as noted hereinabove, the flexible panel 112 of the disclosed enclosure system 100 is secured to the drum 340 of the cartridge assembly 112. In some embodiments, a trailing or inner end 450 of the flexible panel 116 may be received within a longitudinal cutout or slot 452 formed in the drum 340. The flexible panel 116 may be secured within the slot 452 by crimping or otherwise forcing a crimp arm 454 of the drum 340, formed by the formation of the slot 452, against the flexible panel 116 to capture or bite the flexible panel 116 between the crimp arm 454 and the remainder of the drum 340.

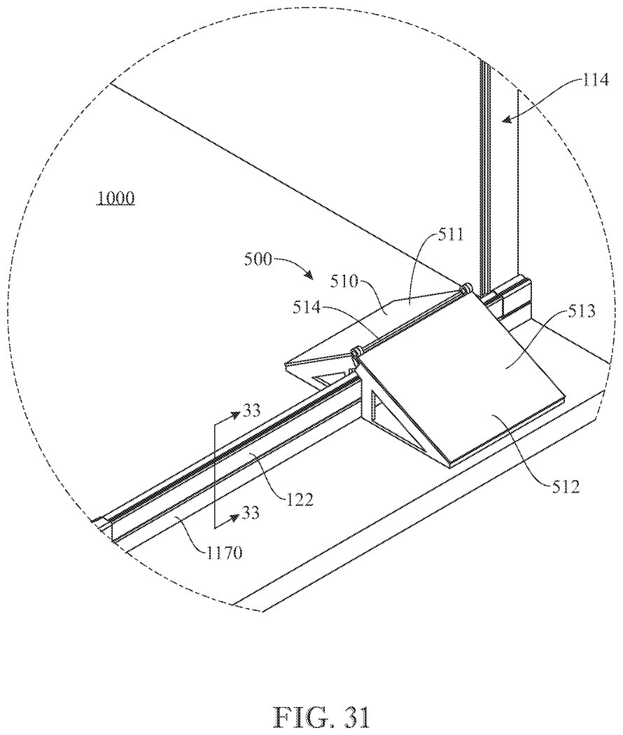

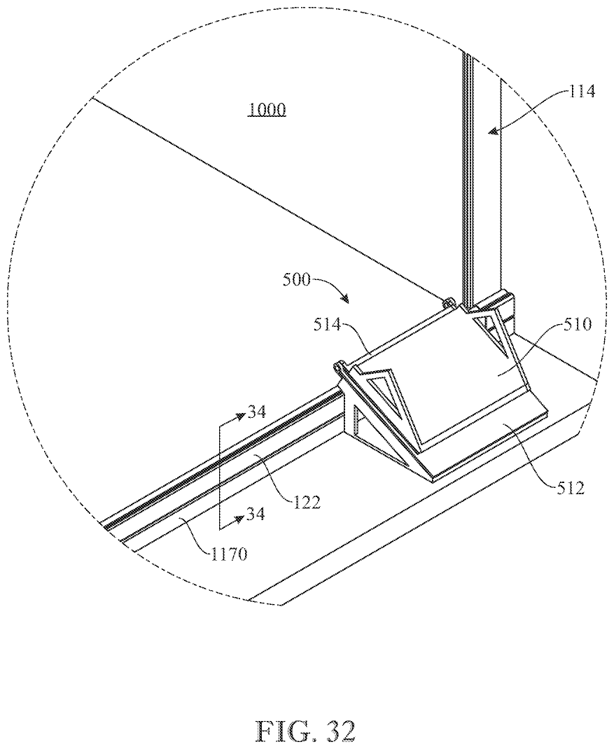

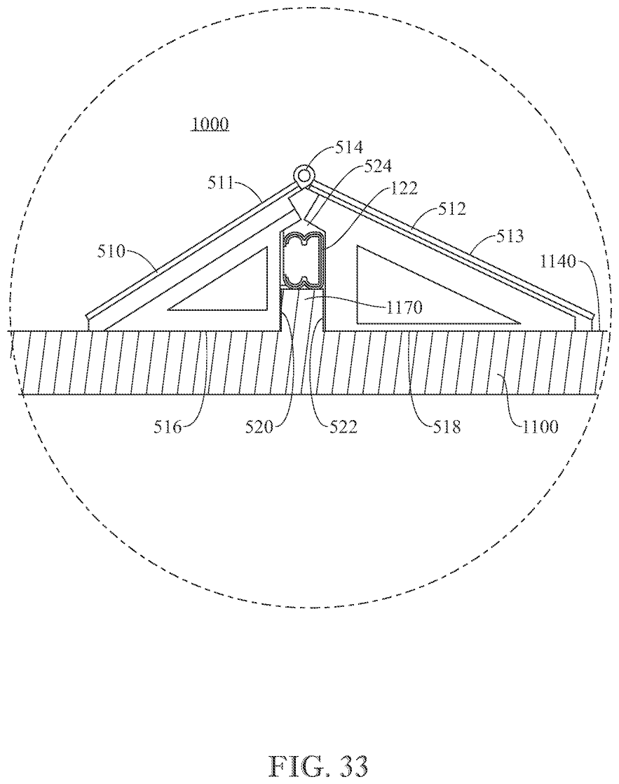

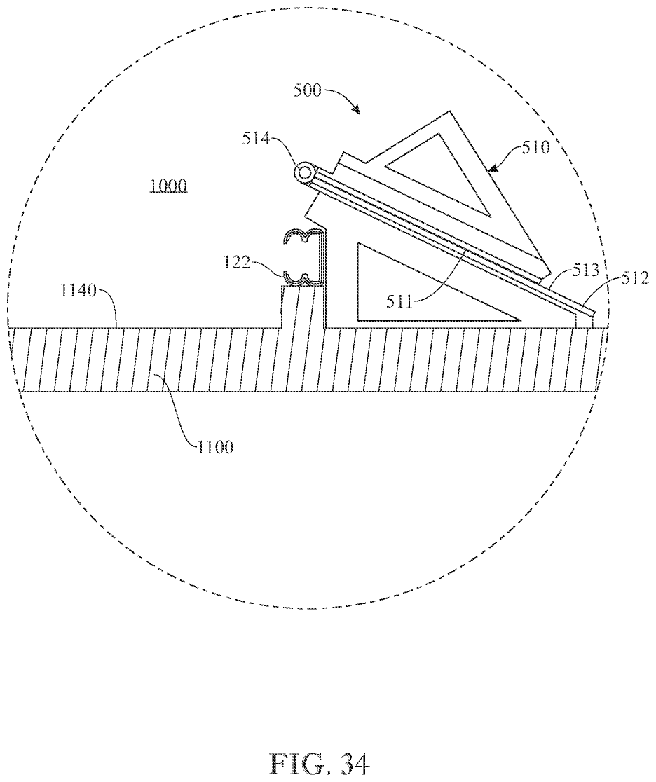

The illustrations of FIGS. 31-34 shown a portable, foldable ramp 500 in accordance with a further aspect of the invention. The portable, foldable ramp 500 may facilitate rolling a wheelchair (not shown) or other wheeled apparatus over the bottom track assembly 122 (FIGS. 1 and 31) of the frame 114 of the disclosed enclosure system 100 to access the shower area 1000. The foldable ramp 500 may include a first ramp 510, a second ramp 512 and a pivot or hinge 514 pivotally connecting the first ramp 510 to the second ramp 512. The ramp 500 may be foldable between a deployed condition (FIGS. 31 and 33) spanning the bottom track assembly 122, and a storage condition (FIGS. 32 and 34) in which the first ramp 510 is folded back over on the second ramp 512 for removal and storage.

As best shown in FIGS. 33 and 34, in the deployed condition, a bottom surface 516 of the first ramp 510 may rest on the upper surface 1140 of the floor 1100 of the shower area 1000 and a bottom surface 518 of the second ramp 512 may rest on the upper surface 1140 of the floor 1100 outside the shower area 1000. A space 524 may be formed between an inner surface 520 of the first ramp 510 and an inner surface 522 of the second ramp 512, the space 524 shaped and size to receive the bottom track assembly 122 and, if present, a bottom wall or other structure 1170 carrying the bottom track assembly 122 and arranged between the upper surface 1140 of the floor 1100 of the shower area 1000 and the upper surface 1140 of the floor 1100 outside the shower area 1000. In some embodiments, the inner surface 520 of the first ramp 510 may abut against the bottom track assembly 122 and/or the structure 1170. Alternatively or additionally, the inner surface 512 of the second ramp 512 may abut against the bottom track assembly 122 and/or the structure 1170. In certain preferred embodiments, both inner surfaces 510 and 512 abut against the structure 1170 to further immobilize the ramp 500. The disclosed portable foldable ramp 500 is movable between the deployed condition and the folded condition. In the deployed condition, shown in FIG. 33, top sloped ramp surfaces 511 and 513 of the first and second ramp 510 and 512, respectively, form an inverted V-shape configuration which facilitates a wheelchair or other wheeled apparatus overcoming the bottom track assembly 122 and structure 1170 (of any) when entering or exiting the shower area 1000. In the folded condition, shown in FIG. 34, the ramp surfaces 511 and 513 may stably and flatly rest against one another to stabilize the foldable ramp 500.

Both the first and second ramps 510 and 512, respectively, may be formed in skeletal form for strength and light weight. The first and second ramps 510 and 512 may be formed from a variety of material, such as, but not limited to, lightweight aluminum, plastic or polymers, wood, combinations thereof, etc. In a non-limiting example, the hinge 514 may include one or more piano type hinges and may be formed from stainless steel.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. An enclosure system for selectively enclosing a shower area or other space, the enclosure system comprising:
a cartridge assembly, comprising a shell, a drum, and a flexible panel, wherein the drum is housed inside the shell and is rotatable relative to the shell about a rotation axis arranged in a longitudinal direction, and wherein the flexible panel is configured retract into or extend from the shell and respectively wind on or unwind from the drum, such that when extended from the shell, the flexible panel may enclose a space; wherein
the cartridge assembly further comprises at least one tensioning mechanism configured to spring-load the drum to rotate in a winding direction for winding the flexible panel on the drum; wherein
each tensioning mechanism of the at least one tensioning mechanism comprises a braking surface rotatable jointly with the drum; and further wherein
the cartridge assembly is configured to adopt a winding configuration, in which the drum rotates in the winding direction and the braking surface of each tensioning mechanism of the at least one tensioning mechanism frictions against the shell.

2. The enclosure system of claim 1, wherein the braking surface is configured to friction against an inner side of the shell oriented towards the drum.

3. The enclosure system of claim 1, wherein said each tensioning mechanism is located at a longitudinal end of the drum.

4. The enclosure system of claim 3, wherein the at least one tensioning mechanism comprises two tensioning mechanisms, wherein each tensioning mechanism of the two tensioning mechanisms is arranged at a respective longitudinal end of the drum.

5. The enclosure system of claim 3, wherein the cartridge assembly further comprises an end cap arranged at said longitudinal end of the drum, the end cap jointly rotatable with the drum, wherein the braking surface of said each tensioning mechanism is provided on the end cap.

6. The enclosure system of claim 3, wherein the braking surface is provided by a radially protruding flange located at said longitudinal end of the drum.

7. The enclosure system of claim 3, wherein said each tensioning mechanism further comprises a torsion spring, wherein a first longitudinal end of the torsion spring is located closer to the longitudinal end of the drum than an opposite, second longitudinal end of the torsion spring, the second longitudinal end of the torsion spring non-rotatably engaged with the drum, wherein the cartridge assembly is configured to adopt an unwinding configuration in which the drum rotates in an unwinding direction opposite to the winding direction, and further wherein:
in both the winding and unwinding configurations, the first longitudinal end of the torsion spring is non-rotatably engaged with the shell, and the drum is rotatable relative to the first longitudinal end of the torsion spring and the shell;
in the unwinding configuration, the drum drives the second longitudinal end of the torsion spring to rotate in the unwinding direction relative to the first longitudinal end of the torsion spring thereby loading the torsion spring; and
in the winding configuration, the torsion spring is loaded and the second longitudinal end of the torsion spring drives the drum to rotate in the winding direction.

8. The enclosure system of claim 7, wherein the second longitudinal end of the torsion spring is longitudinally translatable relative to the drum.

9. The enclosure system of claim 7, wherein said each tensioning mechanism further comprises an inner tube arranged inside the drum, wherein a first longitudinal end of the inner tube is located closer to the longitudinal end of the drum than an opposite, second longitudinal end of the inner tube, and further wherein, in the winding configuration of the cartridge assembly, the second longitudinal end of the torsion spring exerts a longitudinal force on the second longitudinal end of the inner tube towards the longitudinal end of the drum, and the first longitudinal end of the inner tube responsively exerts a force on the braking surface which increases a friction between the braking surface and the shell.

10. The enclosure system of claim 9, wherein the inner tube is translatable relative to the drum along the longitudinal direction.

11. The enclosure system of claim 9, wherein the torsion spring is arranged inside the inner tube.

12. The enclosure system of claim 9, wherein said each tensioning mechanism of the at least one tensioning mechanism further comprises a spring connector attached to the second longitudinal end of the torsion spring, wherein, in the winding configuration of the cartridge assembly, the spring connector abuts against and exerts said longitudinal force on the second longitudinal end of the inner tube.

13. The enclosure system of claim 12, wherein the spring connector is non-rotatably engaged with the second longitudinal end of the torsion spring and with the drum, and is configured to transfer rotation of the drum to the second longitudinal end of the torsion spring in the unwinding configuration of the cartridge assembly, and to transfer rotation of the second longitudinal end of the torsion spring to the drum in the winding configuration of the cartridge assembly.

14. The enclosure system of claim 13, wherein the spring connector is longitudinally slidable relative to the drum, and further wherein, in the unwinding configuration of the cartridge assembly, the torsion spring is extended relative to the winding configuration and thereby exerts less or no longitudinal force on the second longitudinal end of the inner tube towards the longitudinal end of the drum relative to the winding configuration, reducing or eliminating the friction on the shell relative to the winding configuration.

15. The enclosure system of claim 7, wherein the cartridge assembly is further configured to adopt an adjustment configuration, in which the first longitudinal end of the torsion spring is disengaged from the shell and rotatable relative to the shell to modify a rotational position of the first longitudinal end of the torsion spring relative to the second longitudinal end of the torsion spring to adjust a tension of the torsion spring.

16. The enclosure system of claim 15, the cartridge assembly further comprising an adjustment shaft non-rotatably attached to the first longitudinal end of the torsion spring, the adjustment shaft extending through and operable from outside the shell, the adjustment shaft configured to selectively switch between an unlocked configuration and a plurality of locked configurations, wherein, in the unlocked configuration, the adjustment shaft is extended outward of the shell and rotatable relative to the shell, and further wherein, in each locked configuration of the plurality of locked configurations, the adjustment shaft is displaced towards the shell and locked in a different, respective rotational position relative to the shell and prevented from rotating relative to the shell, wherein, in the winding and unwinding configurations of the cartridge assembly, the adjustment shaft is arranged in a selected locked configuration of the plurality of locked configurations, and further wherein, in the adjustment configuration of the cartridge assembly, the adjustment shaft is arranged in the unlocked configuration.

17. The enclosure system of claim 16, wherein, in the unlocked configuration, the adjustment shaft is disengaged from a plurality of stops formed in the shell, and further wherein, in said each locked configuration, the adjustment shaft is prevented from rotating relative to the shell by at least one of said plurality of stops.

18. The enclosure system of claim 1, wherein the cartridge assembly further comprises at least one drain opening formed through a bottom end of the shell and configured to drain water from inside the shell.

19. An enclosure system for selectively enclosing a shower area or other space, the enclosure system comprising:
a cartridge assembly, comprising a shell, a drum, and a flexible panel, wherein the drum is housed inside the shell and is rotatable relative to the shell about a rotation axis arranged in a longitudinal direction, and wherein the flexible panel is configured retract into or extend from the shell and respectively wind on or unwind from the drum, such that when extended from the shell, the flexible panel may enclose a space; wherein
the cartridge assembly further comprises at least one tensioning mechanism configured to spring-load the drum to rotate in a winding direction for winding the flexible panel on the drum; wherein
each tensioning mechanism of the at least one tensioning mechanism is located at a longitudinal end of the drum and comprises a braking surface rotatable jointly with the drum; and further wherein
the cartridge assembly is configured to adopt a winding configuration, in which the drum rotates in the winding direction and the braking surface of each tensioning mechanism of the at least one tensioning mechanism frictions against an inner side of the shell oriented towards the drum.

20. An enclosure system for selectively enclosing a shower area or other space, the enclosure system comprising:
a cartridge assembly, comprising a shell, a drum, and a flexible panel, wherein the drum is housed inside the shell and is rotatable relative to the shell about a rotation axis arranged in a longitudinal direction, and wherein the flexible panel is configured retract into or extend from the shell and respectively wind on or unwind from the drum, such that when extended from the shell, the flexible panel may enclose a space; wherein
the cartridge assembly further comprises at least one tensioning mechanism configured to spring-load the drum to rotate in a winding direction for winding the flexible panel on the drum; wherein
each tensioning mechanism of the at least one tensioning mechanism is located at a longitudinal end of the drum and comprises a braking surface rotatable jointly with the drum, the braking surface provided by a radially protruding flange located at said longitudinal end of the drum; and further wherein
the cartridge assembly is configured to adopt a winding configuration, in which the drum rotates in the winding direction and the braking surface of each tensioning mechanism of the at least one tensioning mechanism frictions against an inner side of the shell oriented towards the drum.
